(19) United States
(12) Patent Application Publication
(10) Pub. No.: US 2025/0387712 A1
(43) Pub. Date: Dec. 25, 2025

(54) Virtual Object Construction Methods and Systems

(71) Applicant: Tencent Technology (Shenzhen) Company Limited, Shenzhen (CN)

(72) Inventors: Jingwen Yang, Shenzhen (CN); Yichi Xiao, Shenzhen (CN); Yunzhi Jiang, Shenzhen (CN); Hao Gao, Shenzhen (CN)

(21) Appl. No.: 19/316,199

(22) Filed: Sep. 2, 2025

Related U.S. Application Data
(63) Continuation of application No. PCT/CN2024/098366, filed on Jun. 11, 2024.

(30) Foreign Application Priority Data
Aug. 22, 2023 (CN) 2024113706354

(51) Int. Cl. A63F 13/58

(52) U.S. Cl. CPC A63F 13/58

(57) ABSTRACT

Virtual character construction methods and systems are described herein. Based on attribute parameters capable of controlling behaviors of non-player characters in a target program and behavior parameters capable of representing behavior styles of the non-player characters in the target program, characters having diversified behavior styles can be efficiently constructed. By changing attribute parameters of generated non-player characters, a to-be-analyzed character who is possibly different from the generated non-player characters in behavior style can be obtained; actual behavior parameters can be obtained by actually operating the to-be-analyzed character in the target program based on the attribute parameters; based on the behavior parameters, the system determines whether a to-be-analyzed character is different from existing characters; and if the behavior style of the character is different from existing non-player characters, the character can be added as a new non-player character. Therefore, automatic non-player character generation and evaluation can be realized based on the attribute parameters and the behavior parameters, so that non-player characters having diversified behavior styles can be efficiently constructed.

### CROSS-REFERENCE TO RELATED APPLICATIONS

This application is a Continuation of PCT Application No. PCT/CN2024/098366, filed Jun. 11, 2024, and further claims priority to Chinese Patent Application No. 2023110706354, filed Aug. 22, 2023, each entitled “Object Construction Method and Related Apparatus”, and each of which is incorporated by reference in its entirety.

### FIELD

This application relates to the field of automatic processing technologies, and in particular, to game object construction technologies.

### BACKGROUND

Non-player characters (NPC) in a game are indispensable characters, and interactions between an NPC and a player character, and behaviors of the NPC in the game are all important factors affecting game experience of a player. The NPC acts as various different characters in the game, and may help the player to resolve problems, provide tasks and challenges, and even enrich plots of the game. The characters can enable the player to feel vividness and realness of a game world, thereby obtaining richer sentiments and experience.

Based on this, to improve game experience of players, game developers need to construct NPCs with diversified styles in a game, to satisfy different NPC interaction requirements. In a related technology, behavior logic of an NPC in a game is determined based on a behavior tree corresponding to the NPC. Construction of NPCs of different styles requires game developers to autonomously design behavior trees respectively corresponding to the NPCs of different styles.

However, construction of the NPCs of different styles in the related technology relies on manual design, and the game developers are required to constantly adjust and design each node and branch in a corresponding behavior tree based on development experience, which consumes a large amount of time and energy. Therefore, construction efficiency of an NPC is relatively low, making it difficult to efficiently construct NPCs with diversified styles.

### SUMMARY

To resolve the foregoing technical problems, this application provides an object construction method, to automatically and efficiently generate non-player objects having diversified styles.

Aspects described herein disclose the following technical solutions:

A first aspect described herein discloses an object construction method, performed by a computer device, and including:
determining a target object in non-player objects included in a non-player object set, the non-player object having an attribute parameter and a behavior parameter, the attribute parameter being configured for controlling a behavior of the non-player object in a target program, the behavior parameter being determined based on the behavior of the non-player object in the target program, and the behavior parameter being configured for representing a behavior style of the non-player object in the target program;
generating an attribute parameter corresponding to a to-be-analyzed object by adding disturbance to the attribute parameter corresponding to the target object;
running the to-be-analyzed object in the target program according to the attribute parameter corresponding to the to-be-analyzed object, and determining a behavior parameter corresponding to the to-be-analyzed object;
determining, according to the behavior parameter corresponding to the to-be-analyzed object and behavior parameters respectively corresponding to the non-player objects included in the non-player object set, whether a behavior style corresponding to the to-be-analyzed object is consistent with behavior styles respectively corresponding to the non-player objects included in the non-player object set; and
adding, when the behavior style corresponding to the to-be-analyzed object is consistent with none of the behavior styles respectively corresponding to the non-player objects included in the non-player object set, the to-be-analyzed object to the non-player object set.

A second aspect described herein discloses an object construction apparatus, including a first determining unit, a generation unit, a second determining unit, a third determining unit, and a first update unit:
the first determining unit being configured to determine a target object in non-player objects included in a non-player object set, the non-player object having an attribute parameter and a behavior parameter, the attribute parameter being configured for controlling a behavior of the non-player object in a target program, the behavior parameter being determined based on the behavior of the non-player object in the target program, and the behavior parameter being configured for representing a behavior style of the non-player object in the target program;
the generation unit being configured to generate an attribute parameter corresponding to a to-be-analyzed object by adding disturbance to the attribute parameter corresponding to the target object;
the second determining unit being configured to run the to-be-analyzed object in the target program according to the attribute parameter corresponding to the to-be-analyzed object, and determine a behavior parameter corresponding to the to-be-analyzed object;
the third determining unit being configured to determine, according to the behavior parameter corresponding to the to-be-analyzed object and behavior parameters respectively corresponding to the non-player objects included in the non-player object set, whether a behavior style corresponding to the to-be-analyzed object is consistent with behavior styles respectively corresponding to the non-player objects included in the non-player object set; and
the first update unit being configured to add, when the behavior style corresponding to the to-be-analyzed object is consistent with none of the behavior styles respectively corresponding to the non-player objects included in the non-player object set, the to-be-analyzed object to the non-player object set.

A third aspect described herein discloses a computer device, including a processor and a memory:
the memory being configured to store a computer program and transmit the computer program to the processor; and
the processor being configured to perform, according to an instruction in the computer program, any object construction method according to the first aspect.

A fourth aspect described herein discloses a computer-readable storage medium, the computer-readable storage medium being configured to store a computer program, and the computer program being configured to perform any object construction method according to the first aspect.

A fifth aspect described herein discloses a computer program product including a computer program, the computer program product, when run on a computer device, causing the computer device to perform any object construction method according to the first aspect.

It can be seen from the foregoing technical solutions that, as described herein, the attribute parameter is configured for controlling a behavior of the non-player object in a target program, and the behavior parameter is determined based on the behavior of the non-player object in the target program, and therefore can represent a behavior style of the non-player object in the target program. As described herein, the behavior of the non-player object in the target program may be affected by adjusting the attribute parameter corresponding to the non-player object, thereby affecting the corresponding behavior style of the non-player object in the target program. Based on this, to construct non-player objects with rich behavior styles, a target object may be first determined from a generated non-player object set, and an attribute parameter corresponding to the to-be-analyzed object may be generated by adding disturbance to an attribute parameter corresponding to the target object. That is, by disturbing the generated attribute parameter of the target object, interference to the behavior style of the target player is implemented, to obtain the to-be-analyzed object that may be different from the target object in terms of the behavior style. The to-be-analyzed object may be run in the target program according to the attribute parameter corresponding to the to-be-analyzed object, thereby determining a behavior parameter corresponding to the to-be-analyzed object, and whether the non-player object set has an object having a behavior style corresponding to the to-be-analyzed object can be analyzed based on the behavior parameter corresponding to the to-be-analyzed object and the behavior parameters respectively corresponding to the non-player objects in the non-player object set. If the non-player object set does not have an object having the behavior style corresponding to the to-be-analyzed object, the to-be-analyzed object may be added to the non-player object set, to automatically update behavior styles of objects in the non-player object set, helping improve a degree of diversification of the behavior styles in the non-player object set. Therefore, by running the non-player object in the non-player object set in the target program, diversified non-player object interaction experience can be brought to a user of the target program, reducing difficulty in constructing diversified non-player objects, reducing dependency of object construction on human experience and requirements for manual participation, and improving object construction efficiency.

### BRIEF DESCRIPTION OF THE DRAWINGS

To describe the technical solutions in the aspects described herein or the related art more clearly, the accompanying drawings required for describing the aspects or the related art are briefly introduced below. The accompanying drawings in the following description show merely some aspects described herein, and a person of ordinary skill in the art may still derive other drawings from these accompanying drawings without creative efforts.

FIG. 1 is a schematic diagram of an object construction method in an actual application scenario according to an aspect described herein.

FIG. 2 is a flowchart of an object construction method according to an aspect described herein.

FIG. 3 is a schematic diagram of an object construction method according to an aspect described herein.

FIG. 4 is a schematic diagram of an object construction method according to an aspect described herein.

FIG. 5 is a flowchart of an object construction method in an actual application scenario according to an aspect described herein.

FIG. 6 is a schematic diagram of an object construction method in an actual application scenario according to an aspect described herein.

FIG. 7 is a schematic diagram of object running in an actual application scenario according to an aspect described herein.

FIG. 8 is a structural block diagram of an object construction apparatus according to an aspect described herein.

FIG. 9 is a structural diagram of a terminal according to an aspect described herein.

FIG. 10 is a structural diagram of a server according to an aspect described herein.

### DETAILED DESCRIPTION

The following describes aspects described herein with reference to the accompanying drawings.

A non-player object refers to another object in a game program other than a player, and the player may experience related content in the game program by interacting with (for example, fighting against or cooperating with) the non-player object. In a related technology, when a non-player object is constructed, a designer needs to manually design a behavior tree corresponding to the non-player object. The behavior tree includes behavior nodes respectively corresponding to different scenes that the non-player object may encounter in a game program. A behavior node is configured for indicating a behavior that the non-player object needs to execute in a scene corresponding to the behavior node. That is, the behavior of the non-player object in the game program may be determined by using a mapping relationship between a scene and a behavior node. As used herein, a non-player object may also be referred to as a non-player character, or NPC.

A behavior style of a non-player object is determined by a behavior of the non-player object in a game program. Therefore, in the related technology, if non-player objects with diversified behavior styles are intended to be constructed, the designer needs to continuously modify each behavior node and branch in a behavior tree, so that non-player objects of different styles can execute different styles of behaviors in the face of the same scene. On one hand, the designer needs to have an extremely strong capability of controlling the behavior style, and object construction difficulty is high. On the other hand, the designer needs to spend a large amount of time and energy in designing and maintaining the behavior tree, and object construction costs are high. Therefore, in an object construction manner in the related technology, it is difficult to efficiently construct non-player objects having diversified behavior styles.

To resolve the foregoing technical problems, this application provides an object construction method. Based on attribute parameters capable of controlling behaviors of non-player objects in a target program and behavior parameters capable of representing behavior styles of the non-player objects in the target program, objects having diversified behavior styles can be efficiently constructed. By disturbing attribute parameters of generated non-player objects, a to-be-analyzed object who is possibly different from the generated non-player objects in behavior style can be obtained; behavior parameters corresponding to the to-be-analyzed object can be obtained by actually operating the to-be-analyzed object in the target program based on the disturbed attribute parameters; based on the behavior parameters, whether a to-be-analyzed object having a behavior style inconsistent with those of the existing non-player objects is constructed can be determined; and if the behavior style of the object is inconsistent with (e.g., dissimilar to) that of the existing non-player objects, the object can be stored as an existing non-player object. Therefore, according to the present application, automatic object construction and evaluation can be realized based on the attribute parameters and the behavior parameters, so that non-player objects having diversified behavior styles can be efficiently constructed.

The method may be performed by a computer device. The computer device is a computer device that can perform object construction, for example, may be a terminal device or a server. The method may be independently performed by a terminal device or a server, or may be applied to a network scenario in which a terminal device communicates with a server, and may be cooperatively performed by the terminal device and the server. The terminal device may be a device such as a mobile phone, a tablet computer, a notebook computer, or a desktop computer. The server may be understood as an application server, or may be a Web server. During actual deployment, the server may be an independent server, or may be a cluster server, a cloud server, or the like.

For ease of understanding the technical solutions provided herein, an object construction method provided in the aspects described herein is described below with reference to an actual application scenario.

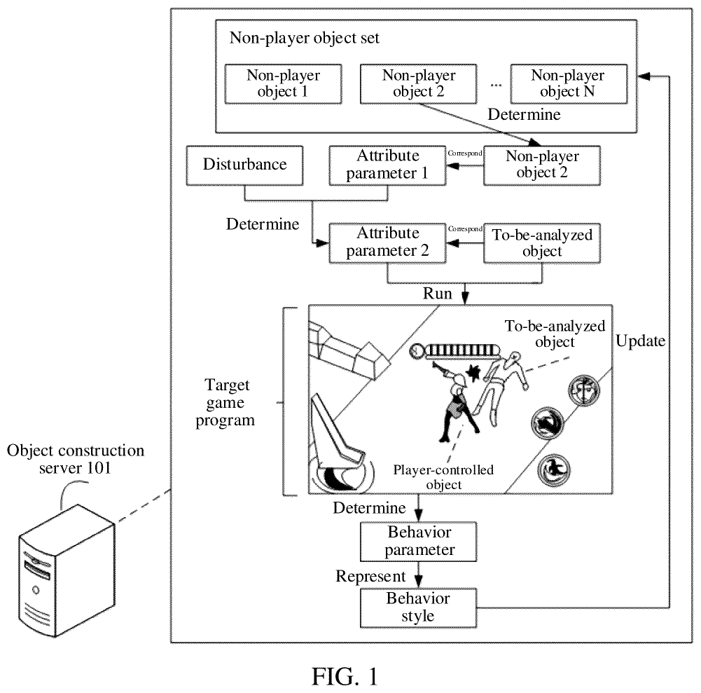

FIG. 1 is a schematic diagram of an object construction method in an actual application scenario according to an aspect described herein. In the actual application scenario, a computer device configured to execute the object construction method may be an object construction server 101 having an object construction capability, and a target program is a target game program.

As shown in FIG. 1, a generated non-player object set includes N non-player objects: a non-player object 1, a non-player object 2, . . . , and a non-player object N. N is an integer greater than 1. The object construction server 101 may first determine a target object for object construction from the non-player object set, for example, the non-player object 2. A new attribute parameter 2 may be obtained by adding disturbance to an attribute parameter 1 corresponding to the non-player object 2. The attribute parameter 2 may be used as an attribute parameter corresponding to a to-be-analyzed object to be analyzed next. Because the attribute parameter can control a behavior of the non-player object in the target game program, and the behavior parameter determined based on the behavior can reflect a behavior style of the non-player object, the new attribute parameter 2 generated by adding disturbance may construct a non-player object with a new behavior style in the target game program.

To analyze an actual behavior style corresponding to the to-be-analyzed object, the object construction server 101 may run the to-be-analyzed object in the target game program based on the attribute parameter 2. As shown in FIG. 1, in the actual application scenario, through interaction between the player-controlled object and the to-be-analyzed object in the target game program, the actual behavior parameter corresponding to the to-be-analyzed object can be determined, so that the behavior style corresponding to the to-be-analyzed object can be determined. If the behavior style is a behavior style absent in the non-player object set, the object construction server 101 may update the non-player object set based on the to-be-analyzed object, so as to generate a set of non-player objects having a plurality of behavior styles. By running the non-player objects in the non-player object set in the target game program, the player can be provided with diversified object interaction experience. It can be learned that this application can implement efficient and automated construction of non-player objects with diversified styles, and has a relatively low degree of dependency on manual participation and human experience.

Next, an object construction method provided herein is described in detail with reference to the accompanying drawings.

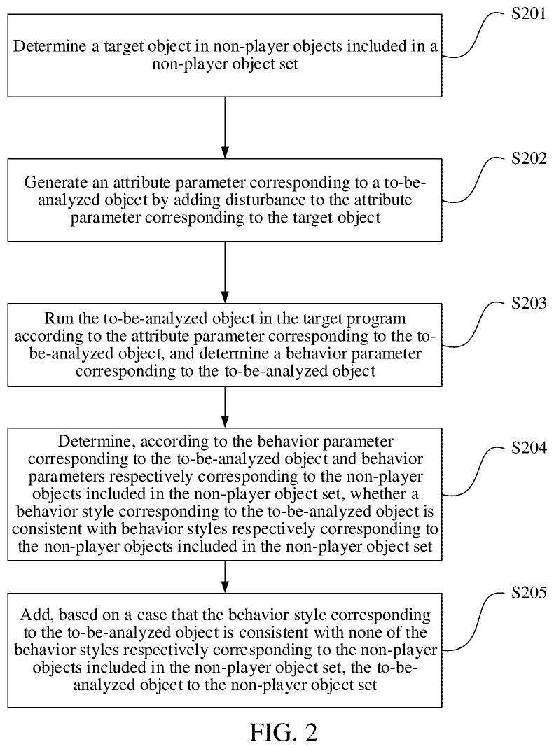

FIG. 2 is a flowchart of an object construction method according to an aspect described herein. In this aspect, a processing device may be any one of the foregoing computer devices having an object construction function. The method includes:

S201: Determine a target object in non-player objects included in a non-player object set.

The non-player object set may include at least one non-player object. The non-player object included in the non-player object set may be a non-player object already generated in the target program, or may be a non-player object already generated in a program other than the target program (the non-player object may run in the target program). This is not limited herein. The target program may be any program that can run a non-player object, for example, may be any game program or animation program. The non-player object refers to an object other than the player object (that is, an object manipulated by the player) in the target program, that is, a virtual object not manipulated by the player. The player object herein may refer to a user of the target program and is not limited to a player of a game program.

Described herein, the non-player object included in the non-player object set has an attribute parameter and a behavior parameter. The attribute parameter determines an attribute of the non-player object in the target program, and therefore may be configured for controlling a behavior of the non-player object in the target program. For example, a parameter of the non-player object A on the attribute “perception range” is 3 m, that is, the non-player object A can perceive another object within 3 m away from the non-player object A in the target program, and this attribute parameter may participate in controlling an attack behavior of the non-player object in the target program. For example, the non-player object may be more inclined to attack another object within 3 m.

The behavior parameter is determined based on the behavior of the non-player object in the target program, and may be configured for representing a behavior style of the non-player object in the target program. For example, by collecting statistics on attack behaviors of a non-player object in a target program, a behavior parameter “attack distance” corresponding to the non-player object may be obtained. Different attack distances correspond to different behavior styles. For example, a behavior style of a non-player object having a relatively short attack distance may be “short-range fighting”, and a behavior style of a non-player object having a relatively long attack distance may be “distance expansion”. In addition, the behavior parameter described herein may also include a plurality of parameter forms, for example, may be a parameter that is directly determined by a behavior of the non-player object, such as an attack distance or a moving speed during behavior execution, or may be a parameter that is determined by using a mapping relationship. For example, the behavior style 1 corresponding to the non-player object may be determined based on attack distances and classification of attack distances in different behavior styles, so that “1” is used as the behavior parameter, and the behavior style can also be represented.

It can be learned from the foregoing descriptions about the parameters that, the attribute parameter can affect the behavior style of the non-player object in the target program to some extent by affecting the behavior of the non-player object in the target program. Based on this, to construct a non-player object that has a behavior style different from that of a generated non-player object, the computer device may modify an attribute parameter of the generated non-player object, and use the modified attribute parameter as an attribute parameter corresponding to a new non-player object.

The computer device may determine a target object from the non-player object set, and the target object is a non-player object at which subsequent attribute parameter adjustment is targeted. The target object may be any non-player object in the non-player object set, or may be determined according to a rule. This is not limited herein.

S202: Generate an attribute parameter corresponding to a to-be-analyzed object by adding disturbance to the attribute parameter corresponding to the target object.

The adding disturbance is a manner of adjusting the attribute parameter. The to-be-analyzed object is a non-player object corresponding to the attribute parameter to which disturbance is added.

In a possible implementation, Random disturbance may be added to the attribute parameter corresponding to the target object. The random disturbance means that an original attribute parameter is adjusted based on a random disturbance parameter value. By adding the random disturbance, the attribute parameter corresponding to the target object can be changed into a random attribute parameter, so that there is a relatively high probability that the changed attribute parameter can be configured for constructing a non-player object having a behavior style inconsistent with a behavior style of the target object. In this case, the to-be-analyzed object is a non-player object corresponding to the attribute parameter to which random disturbance is added.

In another possible implementation, directional disturbance may be added to the attribute parameter corresponding to the target object. The directional disturbance means that an original attribute parameter is adjusted based on a particular disturbance parameter value. In some cases, a new non-player object having a particular style may be needed. In this case, a particular disturbance parameter may be determined according to an attribute parameter corresponding to the particular style, and an attribute parameter of a target object is directionally adjusted according to the particular disturbance parameter. There is a high probability that the adjusted attribute parameter may constitute a non-player object having the needed particular style. In this case, the to-be-analyzed object is a non-player object corresponding to the attribute parameter to which directional disturbance is added.

S203: Run the to-be-analyzed object in the target program according to the attribute parameter corresponding to the to-be-analyzed object, and determine a behavior parameter corresponding to the to-be-analyzed object.

To analyze whether the to-be-analyzed object has a behavior style that is inconsistent with that of the generated non-player object, the computer device may run the to-be-analyzed object in the target program based on the attribute parameter corresponding to the to-be-analyzed object, so that a behavior performed by the to-be-analyzed object in the target program can be obtained, and further the behavior parameter corresponding to the to-be-analyzed object can be determined.

S204: Determine, according to the behavior parameter corresponding to the to-be-analyzed object and behavior parameters respectively corresponding to the non-player objects included in the non-player object set, whether a behavior style corresponding to the to-be-analyzed object is consistent with behavior styles respectively corresponding to the non-player objects included in the non-player object set.

As described above, the behavior parameter can represent a behavior style of the non-player object in the target program, and therefore, the computer device may perform an analysis to determine, based on the behavior parameter corresponding to the to-be-analyzed object and behavior parameters respectively corresponding to the non-player objects included in the non-player object set, a behavior style corresponding to the to-be-analyzed object and behavior styles respectively corresponding to the non-player objects included in the non-player object set.

S205: Add, based on a case that the behavior style corresponding to the to-be-analyzed object is consistent with none of the behavior styles respectively corresponding to the non-player objects included in the non-player object set, the to-be-analyzed object to the non-player object set.

For the purpose of constructing non-player objects with diversified behavior styles, the computer device may add, when the behavior style corresponding to the to-be-analyzed object is consistent with none of the behavior styles respectively corresponding to the non-player objects included in the non-player object set, the to-be-analyzed object to the non-player object set, so that the quantity of behavior styles in the non-player object set can be increased, and then diversified object interaction experience can be brought by running the non-player objects in the non-player object set in the target program. As used herein, “based on” means that an action may be a condition for triggering another action, but does not mean that another action is necessarily triggered, and the another action may also have a plurality of trigger conditions. For example, based on another object construction purpose, the computer device may alternatively choose, according to different rules, to add the to-be-analyzed object to the non-player object set. This is not limited herein.

It can be seen from the foregoing technical solutions that, as described herein, the behavior of the non-player object in the target program may be affected by adjusting the attribute parameter corresponding to the non-player object, thereby affecting the corresponding behavior style of the non-player object in the target program. Based on this, to construct non-player objects with rich behavior styles, a target object may be first determined from a generated non-player object set, and an attribute parameter corresponding to the to-be-analyzed object may be generated by adding disturbance to an attribute parameter corresponding to the target object. That is, by disturbing the generated attribute parameter of the target object, interference to the behavior style of the target player is implemented, to obtain the to-be-analyzed object that may be different from the target object in terms of the behavior style. The to-be-analyzed object may be run in the target program according to the attribute parameter corresponding to the to-be-analyzed object, thereby determining a behavior parameter corresponding to the to-be-analyzed object, and whether the non-player object set has an object having a behavior style corresponding to the to-be-analyzed object can be analyzed based on the behavior parameter corresponding to the to-be-analyzed object and the behavior parameters respectively corresponding to the non-player objects in the non-player object set. If the non-player object set does not have an object having the behavior style corresponding to the to-be-analyzed object, the to-be-analyzed object may be added to the non-player object set, to automatically update behavior styles of objects in the non-player object set, helping improve a degree of diversification of the behavior styles in the non-player object set. Therefore, by running the non-player object in the non-player object set in the target program, diversified non-player object interaction experience can be brought to a user of the target program, reducing difficulty in constructing diversified non-player objects, reducing dependency of object construction on human experience and requirements for manual participation, and improving object construction efficiency.

When running the to-be-analyzed object based on the attribute parameter, the computer device may perform an analysis in the following manner:

When performing operation S203, the computer device may perform operations S2031 to S2032 (not shown in the figure), and operations S2031 to S2032 are a possible implementation of operation S203, including:

S2031: Perform reinforcement learning on an initial object control model according to the attribute parameter corresponding to the to-be-analyzed object, to obtain an object control model corresponding to the to-be-analyzed object.

As described herein, the behavior of the non-player object in the target program is controlled by using the object control model, and the object control model may be configured for determining, according to a scene that the non-player object faces in the target program, a behavior that the non-player object needs to perform. As described above, the behavior of the non-player object in the target program is controlled by the attribute parameter, that is, the behavior of the non-player object is restricted by the attribute parameter, and needs to fit the attribute parameter corresponding to the non-player object. Therefore, the computer device may perform reinforcement learning on the initial object control model according to the attribute parameter, may enable, in a process of the reinforcement learning, the initial object control model to learn how to determine a behavior fitting the attribute parameter, and further may obtain the object control model configured for controlling a behavior of the to-be-analyzed object in the target program.

S2032: Run the to-be-analyzed object in the target program by using the object control model, and determine the behavior parameter corresponding to the to-be-analyzed object.

Specifically, when performing operation S2031, the computer device may perform operations S20311 to S20314 (not shown in the figure), and operations S20311 to S20314 are a possible implementation of operation S2031, including:

S20311: Obtain a scene parameter corresponding to the to-be-analyzed object in the target program.

The scene parameter is configured for identifying a behavior scene that the to-be-analyzed object faces in the target program; as described herein, to perform the behavior of the non-player object in the target program relatively appropriate, the computer device may make, based on the behavior scene that the non-player object faces in the target program, a decision about a behavior that the non-player object needs to perform, so that the behavior can fit the behavior scene that the non-player object faces, thereby improving the appropriateness of the behavior. For example, when the behavior scene is that there is another object within a distance, the computer device may control the non-player object to perform a behavior such as attacking or moving.

Based on this, to enable the object control model to appropriately control a behavior of the to-be-analyzed object in the target program, model training may be performed to enable the object control model to have a capability of outputting, based on the scene parameter, a behavior that the to-be-analyzed object needs to perform.

S20312: Determine a behavior control parameter based on the scene parameter by using the initial object control model.

The behavior control parameter is configured for controlling the to-be-analyzed object to perform a target behavior in the foregoing behavior scene.

S20313: Determine a reward feedback degree for the initial object control model according to a fitting degree between the target behavior and the attribute parameter corresponding to the to-be-analyzed object.

As described above, the attribute parameter is configured for controlling a behavior of the non-player object in the target program. That is, the behavior of the non-player object in the target program needs to fit an attribute parameter corresponding to the non-player object. During model training, to enable the object control model to determine a behavior control parameter fitting the attribute parameter, the computer device may determine a reward feedback degree of the initial object control model in the reinforcement learning based on a fitting degree between the target behavior executed by the to-be-analyzed object controlled by the initial object control model and the attribute parameter corresponding to the to-be-analyzed object. The fitting degree between the target behavior and the attribute parameter is a fitting degree between the attribute parameter represented by the target behavior and the attribute parameter corresponding to the to-be-analyzed object. The attribute parameter represented by the target behavior is an attribute parameter actually reflected when the initial object control model controls a behavior of the to-be-analyzed object. For example, the target behavior is “attacking another object”. When the target behavior is executed, an average attack distance of the to-be-analyzed object is 10 m, and therefore the represented attribute parameter “perception range” is approximately 10 m. If the attribute parameter corresponding to the to-be-analyzed object is “perception range 5 m”, it indicates that a difference between the attribute parameter actually represented by the target behavior and the attribute parameter corresponding to the to-be-analyzed object is relatively large, that is, a fitting degree between the target behavior and the attribute parameter corresponding to the to-be-analyzed object is relatively low. Otherwise, if the attribute parameter “perception range” represented by the target behavior is closer to 5 m, the fitting degree between the target behavior and the attribute parameter corresponding to the to-be-analyzed object is higher. Specifically, corresponding fitting degree determining rules may be set for different types of attribute parameters, so that the fitting degree determining rules are configured for determining, according to a difference between the attribute parameter represented by the target behavior and the attribute parameter corresponding to the to-be-analyzed object, a fitting degree between the target behavior and the attribute parameter corresponding to the to-be-analyzed object.

In the reinforcement learning, an objective of adjusting a model parameter is to enable a model to obtain a larger reward feedback degree. As described herein, the reward feedback degree is positively correlated to the fitting degree. Therefore, determining the reward feedback parameter based on the fitting degree helps the model learn how to determine a behavior that better fits the attribute parameter. Specifically, when the reward feedback degree is determined according to the fitting degree, a mapping table of fitting degrees and reward feedback degrees may be preset, and then a reward feedback degree corresponding to a current fitting degree is searched for in the mapping table.

For example, if the attribute parameter corresponding to the to-be-analyzed object is “perception range 3 m”, a behavior fitting the attribute parameter needs to be interacting with another object within 3 m in the target program. The computer device may determine, based on the behavior control parameter outputted by the initial object control model, an interaction distance that actually corresponds to the target behavior in the target program. If the interaction distance is beyond 3 m, and a difference between the interaction distance and 3 m is relatively large, it indicates that the fitting degree between the target behavior and the attribute parameter is relatively small. Therefore, a relatively small reward feedback degree may be given. If the interaction distance is close to 3 m and is beyond 3 m, indicating that the fitting degree between the target behavior and the attribute parameter is relatively large, a relatively large reward feedback degree is given. Therefore, in this manner, the initial object control model may learn to control the to-be-analyzed object to interact with another object within a distance of approximately 3 m.

S20314: Adjust a model parameter corresponding to the initial object control model based on the reward feedback degree, to obtain the object control model.

When the model parameter corresponding to the initial object control model is adjusted, the computer device may enable the initial object control model to gradually obtain a relatively large reward feedback degree, so that the initial object control model may learn how to determine a behavior that fits the attribute parameter, to obtain the object control model. The object control model may be configured for controlling a behavior of the to-be-analyzed object in the target program based on the scene parameter corresponding to the to-be-analyzed object in the target program, that is, determining the behavior control parameter based on the scene parameter, and enabling the to-be-analyzed object to execute a behavior corresponding to the behavior control parameter in the target program.

In this way, in the foregoing manner, an object control model having a behavior control parameter fitting an attribute parameter of the to-be-analyzed object can be determined through training, and running of the to-be-analyzed object in the target program is controlled by using the object control model, so as to ensure that a behavior style of the to-be-analyzed object fits an attribute parameter corresponding to the to-be-analyzed object, that is, help to accurately determine a behavior style corresponding to the to-be-analyzed object, and further help to subsequently accurately determine whether to add the to-be-analyzed object to the non-player object set, that is, ensure that the non-player object set is effectively diversified, thereby avoiding adding a non-player object having no new behavior style to the non-player object set.

Because the to-be-analyzed object described herein is generated by adding disturbance, a plurality of to-be-analyzed objects can be theoretically generated based on each target object. A relatively large workload may be brought if each to-be-analyzed object is placed into the target program to perform a behavior parameter analysis. In a possible implementation, to reduce workload required for object construction, and more efficiently construct non-player objects having diversified styles, before putting to-be-analyzed objects into the target program for running, the computer device may first analyze probabilities that a new behavior style appears in the to-be-analyzed objects, and put only a to-be-analyzed object having a relatively high probability that the new behavior style appears in the to-be-analyzed object into the target program for running and analysis.

There may be a plurality of manners of analyzing the probability of whether the to-be-analyzed object has the new style. In a possible implementation, because an attribute parameter is a fundamental factor affecting a behavior style, if there is a large difference between attribute parameters of two non-player objects, there is usually a large probability that the two non-player objects correspond to different behavior styles. Based on this, the computer device may predict, based on a difference between attribute parameters, a probability that a new behavior style appears in the to-be-analyzed object.

The computer device may determine differences between the attribute parameter corresponding to the to-be-analyzed object and the attribute parameters respectively corresponding to the non-player objects included in the non-player object set. Larger differences can indicate, to some extent, a higher probability that the to-be-analyzed object and the non-player objects included in the non-player object set have different behavior styles. Therefore, when performing operation S203, the computer device may perform operation S2033 (not shown in the figure), and operation S2033 are a possible implementation of operation S203, including:

S2033: Run, if the differences between the attribute parameter corresponding to the to-be-analyzed object and the attribute parameters respectively corresponding to the non-player objects included in the non-player object set are all greater than a first preset threshold, the to-be-analyzed object in the target program according to the attribute parameter corresponding to the to-be-analyzed object, and determine the behavior parameter corresponding to the to-be-analyzed object.

The computer device may preset a first preset threshold. If the differences between the attribute parameter corresponding to the to-be-analyzed object and the attribute parameters respectively corresponding to the non-player objects included in the non-player object set are greater than the first preset threshold, it indicates that the to-be-analyzed object and each non-player object in the non-player object set have a relatively large difference in attribute parameters. Therefore, there is a large probability that a corresponding behavior style is different from those of the existing non-player objects. Therefore, the computer device may determine that the to-be-analyzed object is a to-be-analyzed object having a relatively high probability that a new behavior style appears in the to-be-analyzed object, and put the to-be-analyzed object into the target program for actual analysis.

Otherwise, if the condition is not satisfied, it indicates that there is a non-player object that is relatively close to the to-be-analyzed object in the non-player object set in terms of attribute parameters, thereby indicating that there is a large probability that the behavior style corresponding to the to-be-analyzed object exists in the non-player object set. Therefore, the computer device might not further analyze the behavior parameter corresponding to the to-be-analyzed object, thereby reducing workload and time required for object construction to some extent, and further improving object construction efficiency.

The object filtering is performed based on a difference between attribute parameters, and the same behavior style may correspond to a plurality of different attribute parameters. Therefore, if the non-player object set includes a comprehensive attribute parameter composition for each behavior style, this case helps to more accurately filter out a to-be-analyzed object of a new behavior style based on the attribute parameters.

Based on this, in a possible implementation, After the to-be-analyzed object that can be putted into the target program for behavior style analysis is filtered out in the foregoing manner, and behavior style determination is completed, if the differences between the attribute parameter corresponding to the to-be-analyzed object and the attribute parameters respectively corresponding to the non-player objects included in the non-player object set are all greater than the first preset threshold and the non-player object set has a non-player object corresponding to a behavior style consistent with the behavior style corresponding to the to-be-analyzed object, it indicates that the attribute parameter corresponding to the to-be-analyzed object is another attribute parameter composition corresponding to an existing behavior style. In this case, the computer device may add the to-be-analyzed object to the non-player object set, and therefore can separately calculate attribute parameter differences from a plurality of attribute parameter compositions of the behavior style when subsequently filtering to-be-analyzed objects based on the attribute parameters. If a difference between an attribute parameter corresponding to a to-be-analyzed object and an attribute parameter reaches a first preset threshold, but a difference between the attribute parameter corresponding to the to-be-analyzed object and another attribute parameter is less than the first preset threshold, it can still be determined that there is a large probability that a behavior style corresponding to the to-be-analyzed object is an existing behavior style. In this manner, accuracy of filtering the to-be-analyzed object based on the attribute parameter can be further increased, thereby further improving object construction efficiency.

As described above, the attribute parameter can directly affect the behavior style of the non-player object. Therefore, to some extent, the attribute parameter can also play a role of representing the behavior style corresponding to the non-player object. Based on this, in another possible implementation, the computer device may perform detailed analysis on the attribute parameter by using a model, to predict a behavior style corresponding to the to-be-analyzed object.

The computer device may determine a predicted behavior parameter corresponding to the to-be-analyzed object by using a behavior parameter prediction model and according to the attribute parameter corresponding to the to-be-analyzed object. The predicted behavior parameter is a behavior parameter that is predicted by using the behavior parameter prediction model and that corresponds to the to-be-analyzed object in the target program. The behavior parameter prediction model is configured for predicting a behavior parameter corresponding to the non-player object in the target program based on the attribute parameter corresponding to the non-player object. When performing operation S203, the computer device may perform operation S2034 (not shown in the figure), and operation S2034 are a possible implementation of operation S203, including:

S2034: Run, if the differences between the predicted behavior parameter and the behavior parameters respectively corresponding to the non-player objects included in the non-player object set are all greater than a second preset threshold, the to-be-analyzed object in the target program according to the attribute parameter corresponding to the to-be-analyzed object, and determine the behavior parameter corresponding to the to-be-analyzed object.

The computer device may preset a second preset threshold, and the second preset threshold is configured for judging whether there is a large difference between behavior parameters. A behavior parameter can represent a behavior style corresponding to a non-player object. Therefore, if the differences between the predicted behavior parameter corresponding to the to-be-analyzed object and the behavior parameters respectively corresponding to the non-player objects in the non-player object set are all greater than the second preset threshold, it indicates that the to-be-analyzed object and the existing non-player objects have large differences in terms of behavior parameters. Therefore, there is a relatively high probability that the to-be-analyzed object may have a behavior style that is inconsistent with those of the existing non-player objects, so that the computer device may put the to-be-analyzed object into the target program for actual analysis.

Otherwise, if the condition is not satisfied, it indicates that there is a non-player object in the non-player object set that may be close to the to-be-analyzed object in terms of behavior parameters, that is, there is a relatively large probability that the existing non-player objects include a non-player object having a behavior style consistent with that of the to-be-analyzed object, and the computer device might not put the to-be-analyzed object into the target program for actual analysis.

Specifically, in a possible implementation, the behavior parameter prediction model may be obtained through training in the following manner:

The computer device may first obtain a sample non-player object set, where the sample non-player object set includes a plurality of sample non-player objects, the plurality of sample non-player objects have corresponding attribute parameters and behavior parameters, and both the attribute parameters and the behavior parameters are actual parameters corresponding to the sample non-player objects.

The computer device may use each of the plurality of sample non-player objects as a target sample object, and determine, by using an initial behavior parameter prediction model, a to-be-determined behavior parameter according to an attribute parameter corresponding to the target sample object, where the initial behavior parameter prediction model is a model on which model training needs to be performed, and the to-be-determined behavior parameter is the behavior parameter that is predicted by using the initial behavior parameter prediction model and that corresponds to the target sample object.

Therefore, according to the difference between the to-be-determined behavior parameter and the behavior parameter corresponding to the target sample object, a difference between the behavior parameter predicted by the initial behavior parameter prediction model and the behavior parameter actually corresponding to the target sample object can be reflected, so that accuracy of the initial behavior parameter prediction model when predicting the behavior parameter can be reflected. Based on this, the computer device may adjust, according to the difference, the model parameter corresponding to the initial behavior parameter prediction model, so that a difference between the to-be-determined behavior parameter predicted by the initial behavior parameter prediction model and the actual behavior parameter gradually decreases, thereby enabling the initial behavior parameter prediction model to learn how to accurately predict the behavior parameter based on the attribute parameter, to obtain the behavior parameter prediction model.

In this way, in the foregoing manner, the behavior parameter prediction model is configured for determining, according to the attribute parameter of the to-be-analyzed object, the predicted behavior parameter corresponding to the to-be-analyzed object, and then determine, according to differences between the predicted behavior parameter corresponding to the to-be-analyzed object and behavior parameters respectively corresponding to the existing non-player objects, whether to run the to-be-analyzed object in the target program, to further determine the behavior style corresponding to the to-be-analyzed object. Initial filtering on the to-be-analyzed object is implemented, to avoid running related resources required by the to-be-analyzed object.

As described above, the target object may be randomly selected, or may be selected in different manners based on different object construction objectives. Next, a plurality of selection manners of selecting a target object are described in detail.

The behavior parameter may include a plurality of behavior parameter dimensions, and behavior style dimensions ensured by different behavior parameter dimensions are different. For example, the behavior parameter may include two dimensions: a moving speed and an attack distance. A behavior parameter corresponding to the moving speed can represent a behavior style in the behavior style dimension of “flexible/heavy”, and a behavior parameter corresponding to the attack distance can represent a behavior style in the behavior style dimension of “short-range fighting/distance expansion”.

There may be a plurality of behavior styles in the same behavior style dimension, and the behavior styles are controlled by attribute parameters. Therefore, if an object having a new behavior style in a behavior style dimension is intended to be constructed, non-player objects corresponding to the plurality of behavior styles in the behavior style dimension may be selected from the non-player object set. For example, in a possible implementation, the behavior parameter may include a behavior parameter in a target behavior parameter dimension, the target behavior parameter dimension may be any behavior parameter dimension, the behavior parameter in the target behavior parameter dimension is configured for representing a behavior style in a target behavior style dimension, and a plurality of behavior styles are included in the target behavior style dimension.

When performing operation S201, the computer device may perform operations S2011 to S2012 (not shown in the figure), and operations S2011 to S2012 are a possible implementation of operation S201, including:

S2011: Determine the plurality of to-be-processed objects in the non-player objects included in the non-player object set based on the behavior parameters respectively corresponding to the non-player objects included in the non-player object set.

The plurality of to-be-processed objects are non-player objects having different corresponding behavior styles in the target behavior style dimension. Because the to-be-processed objects have different behavior styles in the target behavior style dimension, the attribute parameters corresponding to the to-be-processed objects can more comprehensively reflect impact of the attribute parameter on a behavior style in the target behavior style dimension, that is, the attribute parameters corresponding to the to-be-processed objects can more comprehensively reflect attribute parameter characteristics respectively corresponding to different behavior styles in the target behavior style dimension. Therefore, when disturbance is added to the attribute parameters of the to-be-processed objects, an attribute parameter corresponding to a new behavior style in the target behavior style dimension can be constructed with a larger probability.

S2012: Determine each of the plurality of to-be-processed objects as the target object.

The computer device may use each of a plurality of to-be-processed objects as the target object, and perform the foregoing processing process on the target object, so as to construct a to-be-analyzed object for each target object. There is a relatively high probability that a new behavior style in the target behavior style dimension appears in the to-be-analyzed objects, which helps improve object construction accuracy and object construction efficiency, and can also satisfy a construction requirement of performing object construction for a specific behavior style dimension.

For example, if a non-player object having a new behavior style in a behavior style dimension A is intended to be constructed, the computer device may select, according to the behavior parameters corresponding to the non-player objects in the non-player object set, non-player objects respectively corresponding to a plurality of behavior styles in the behavior style dimension A as a plurality of to-be-processed objects.

Because different non-player objects usually correspond to different attribute parameters, if there is a plurality of non-player objects in a behavior style, it indicates that an attribute parameter interval corresponding to the behavior style is relatively large. Therefore, it is usually difficult to obtain a new behavior style in the same behavior style dimension by adjusting an attribute parameter of a non-player object in the behavior style. Based on this, in a possible implementation, the computer device may select, with reference to the quantities of non-player objects respectively corresponding to behavior styles in the non-player object set under the target behavior style dimension, to-be-processed objects corresponding to the behavior styles.

When performing operation S2011, the computer device may perform operations S20111 to S20112 (not shown in the figure), and operations S20111 to S20112 are a possible implementation of operation S2011, including:

S20111: Determine, based on the behavior parameters respectively corresponding to the non-player objects included in the non-player object set, a quantity of non-player objects respectively corresponding to a plurality of behavior styles in the target behavior style dimension in the non-player object set.

S20112: Determine a plurality of to-be-processed objects in the non-player objects included in the non-player object set based on the quantity of non-player objects respectively corresponding to a plurality of behavior styles in the target behavior style dimension in the non-player object set.

The target behavior style may be any behavior style under the target behavior style dimension. A larger number of objects corresponding to the target behavior style in the non-player object set indicates a wider attribute parameter interval corresponding to the target behavior style. Therefore, when the attribute parameter of the non-player object corresponding to the target behavior style is adjusted, the adjusted attribute parameter is still prone to fall within the attribute parameter range corresponding to the target behavior style, so that the to-be-analyzed object whose behavior style is not changed is easily obtained. Therefore, the computer device may reduce adjustment of an attribute parameter of a non-player object of the target behavior style.

Otherwise, a smaller number of objects corresponding to the target behavior style in the non-player object set indicates a narrower attribute parameter interval corresponding to the target behavior style. Therefore, when the attribute parameter of the non-player object corresponding to the target behavior style is adjusted, the behavior style corresponding to the to-be-analyzed object corresponding to the adjusted attribute parameter in the target behavior style dimension is easily changed. Therefore, the computer device may increase adjustment of an attribute parameter of a non-player object of the target behavior style. Based on this, as described herein, a quantity of objects corresponding to a target behavior style in the plurality of to-be-processed objects is negatively correlated to a quantity of non-player objects corresponding to the target behavior style in the non-player object set, thereby improving a success rate of constructing a non-player object of a new behavior style.

In addition, although different non-player objects may correspond to the same behavior style, capabilities of the non-player objects in the target program may be different. For example, when a non-player object that is also in the behavior style of “short-range fighting” fights against another object in the target program, some non-player objects may have a relatively high probability of winning in the fighting, and some non-player objects may have a relatively low probability of winning in the fighting. An object capability of a non-player object is also one of important factors affecting program use experience of a player. If a non-player object in the target program has a poor object capability, the non-player object possibly cannot effectively interact with the player, thereby bringing poor program use experience to the player.

Based on this, in a possible implementation, the computer device may further determine task execution success rates respectively corresponding to the non-player objects included in the non-player object set, the task execution success rate being a success rate of executing a target task by the non-player object in the target program, and the target task being configured for testing an object capability of the non-player object. For example, when the object capability that needs to be tested is a fighting capability, the target task may be defeating another object in the target program; and when the object capability that needs to be tested is an interaction capability, the target task may be interacting with the player in the target program.

When performing operation S2011, the computer device may perform operation S20113 (not shown in the figure), and operation S20113 are a possible implementation of operation S2011, including:

S20113: Determine the plurality of to-be-processed objects in the non-player objects included in the non-player object set based on the behavior parameters and the task execution success rates respectively corresponding to the non-player objects included in the non-player object set.

The computer device may preset a third preset threshold. The third preset threshold is configured for determining whether the non-player object has a relatively high task execution success rate. Task execution success rates respectively corresponding to the plurality of to-be-processed objects are all greater than the third preset threshold, that is, the plurality of to-be-processed objects all have relatively strong object capabilities to some extent, so that when object construction is performed based on these to-be-processed objects, a constructed to-be-analyzed object can also have a relatively high object capability with a high probability, thereby ensuring stability of an object capability of a non-player object in the target program, and ensuring program use experience brought by the non-player object.

As described above and as described herein, by using the foregoing manner, a non-player object having a specified behavior style dimension can be efficiently constructed. Specifically, to satisfy an actual object construction requirement, a behavior style dimension targeted during object construction may be determined by an actual request during object construction.

The computer device may obtain an object construction request, the object construction request being configured for requesting to construct a non-player object corresponding to a to-be-constructed behavior style dimension. Therefore, the object construction request can represent a construction requirement for a non-player object having a new behavior style in a to-be-constructed behavior style dimension.

Therefore, to meet the construction requirement, when performing operation S201, the computer device may perform operation S20114 (not shown in the figure), and operation S20114 are a possible implementation of operation S2011, including:

S20114: Determine the to-be-constructed behavior style dimension as the target behavior style dimension, and determine the plurality of to-be-processed objects in the non-player objects included in the non-player object set based on the behavior parameters respectively corresponding to the non-player objects included in the non-player object set.

Therefore, with reference to the foregoing object construction manner, after the to-be-constructed behavior style dimension is determined as the target behavior style dimension, a non-player object having a new behavior style in the to-be-constructed behavior style dimension can be efficiently constructed.

Because the behavior parameter may include a plurality of behavior parameter dimensions, and the target object is selected based on a behavior parameter in a specified dimension, more behavior parameter dimensions included in the specified dimension indicates more complex selection of the target object, higher complexity during object construction, and weaker pertinence for a single behavior parameter dimension. Based on this, in a possible implementation, to reduce processing pressure of the computer device during object construction, the computer device may perform a plurality of rounds of object construction for a plurality of behavior parameter dimensions, and allocate processing pressure of object construction in the plurality of behavior parameter dimensions to the plurality of rounds of object construction.

In this implementation, the object construction is configured for completing an object construction task, the object construction task includes a plurality of rounds of object construction, the behavior parameter includes a plurality of behavior parameter dimensions, behavior style dimensions represented by behavior parameters in the different behavior parameter dimensions are different.

When performing operation S201, the computer device may perform operations S20115 to S20116 (not shown in the figure), and operations S20115 to S20116 are a possible implementation of operation S2011, including:

S20115: Determine the target behavior parameter dimension in the plurality of behavior parameter dimensions during an i^{th} round of object construction in the plurality of rounds of object construction.

The target behavior parameter dimension is a behavior parameter dimension at which the i^{th} round of object construction is targeted. The target behavior parameter dimension is any behavior parameter dimension of the plurality of behavior parameter dimensions, and may be one behavior parameter dimension, or may be a plurality of behavior parameter dimensions, where i is a positive integer.

S20116: Determine the plurality of to-be-processed objects in the non-player objects included in the non-player object set based on the behavior parameters respectively corresponding to the non-player objects included in the non-player object set.

After the target behavior parameter dimension is determined, by using the foregoing manner, it may be determined from the non-player objects that construction of a to-be-processed object having a new behavior style in the target behavior style dimension corresponding to the target behavior parameter dimension is facilitated, so that the i^{th} round of object construction may be performed based on the to-be-processed object, that is, the to-be-analyzed object is constructed by using the foregoing manner, and analysis is performed in the target program.

The computer device may judge, after update of the non-player object set is completed by using a to-be-analyzed object of the i^{th} round of object construction, whether a non-player object included in the non-player object set satisfies a behavior style requirement corresponding to the object construction task. The behavior style requirement can identify a behavior style of a non-player object that needs to be constructed by the object construction task. Updating the non-player object set by using the to-be-analyzed object of the i^{th} round of object construction may be placing a to-be-analyzed object satisfying the requirement into the non-player object set, or none of to-be-analyzed objects satisfies the requirement, that is, the non-player object set is not changed. That is, as long as judging whether each to-be-analyzed object generated during the i^{th} round of object construction is added to the non-player object set is completed, it may be considered that the updating the non-player object set by using the to-be-analyzed object of the i^{th} round of object construction is completed.

If the behavior style requirement is satisfied, it indicates that the non-player object set has a non-player object required by the object construction task, and therefore, object construction may be stopped. Otherwise, if the behavior style requirement is not satisfied, it indicates that a non-player object satisfying the behavior style requirement further needs to be constructed through a subsequent object construction behavior. Therefore, the (i+1)^{th} round of object construction of the plurality of rounds of object construction may be performed. In the (i+1)^{th} round of object construction, the target behavior parameter dimension may be reselected to perform object construction, to construct non-player objects of different behavior styles.

Because each round of object construction is performed for a specific behavior parameter dimension, compared with construction performed for all behavior parameter dimensions at a time, a probability of constructing a non-player object of a new behavior style in a behavior style dimension corresponding to the specific behavior parameter dimension is higher, thereby improving pertinence of each round of object construction, improving a success rate of each round of object construction, and further facilitating overall improvement of object construction efficiency.

Similar to the behavior parameter, in a possible implementation, the attribute parameter may also include a plurality of attribute parameter dimensions. As described above, the attribute parameter of the to-be-analyzed object is generated by adding disturbance to the attribute parameter corresponding to the generated non-player object. If the attribute parameter includes many attribute parameter dimensions, many attribute parameters need to be adjusted during each time of object construction, which also brings a large processing pressure to object construction. Based on this, in each round of object construction, the computer device may select only attribute parameters in some attribute parameter dimensions for adjustment, to allocate the processing pressure brought by the attribute parameter adjustment to a plurality of rounds of object construction.

Specifically, the computer device may determine the target attribute parameter dimension in the plurality of attribute parameter dimensions during the i^{th} round of object construction, where the target attribute parameter dimension may be any attribute parameter dimension of the plurality of attribute parameter dimensions, and may be one or more attribute parameter dimensions. When performing operation S202, the computer device may perform operation S2021 (not shown in the figure), and operation S2021 are a possible implementation of operation S202, including:

S2021: Generate the attribute parameter corresponding to the to-be-analyzed object by adding random disturbance to an attribute parameter corresponding to the target object in the target attribute parameter dimension.

Because in the i^{th} round, only attribute parameters in the target attribute parameter dimension need to be adjusted, and attribute parameters in all attribute parameter dimensions do not need to be adjusted, processing pressure of the i^{th} round of object construction can be reduced to some extent. When performing the (i+1)^{th} round of object construction, the computer device may re-determine a new target attribute parameter dimension from the plurality of attribute parameter dimensions.

Next, how to accurately analyze, based on a behavior parameter, a behavior style corresponding to a non-player object is described in detail.

Different behavior styles usually have respective corresponding parameter intervals in terms of behavior parameters. For example, in the behavior parameter dimension of “average attack distance”, a parameter interval corresponding to the behavior style of “short-range fighting” may be 0 to 3 m, indicating that the non-player object is relatively inclined to attack at a relatively short distance in the target program, and a parameter interval corresponding to the behavior style of “distance expansion” may be 3 to 10 m, that is, the non-player object is relatively inclined to attack at a relatively long distance in the target program. Based on this, in a possible implementation, when determining a behavior style based on a behavior parameter, the computer device may perform division based on different behavior parameter intervals corresponding to different behavior styles.

When performing operation S204, the computer device may perform operations S2041 to S2042 (not shown in the figure), and operations S2041 to S2042 are a possible implementation of operation S204, including:

S2041: Determine, according to a behavior parameter corresponding to a to-be-determined object and parameter intervals respectively corresponding to a plurality of behavior styles, a target parameter interval to which the behavior parameter corresponding to the to-be-determined object belongs.

The to-be-determined object is any one of the to-be-analyzed object and the non-player objects included in the non-player object set, and parameter intervals corresponding to different behavior styles are different. Therefore, when the behavior parameters corresponding to the non-player objects fall within different parameter intervals, the determined behavior styles are different.

S2042: Determine a behavior style corresponding to the target parameter interval as a behavior style corresponding to the to-be-determined object.

In this way, in the foregoing manner, the behavior style corresponding to the to-be-determined object is determined according to the parameter interval to which the behavior parameter belongs, so that the behavior style can be efficiently and conveniently determined, thereby helping improve object construction efficiency.

The behavior style corresponding to the non-player object in the target program is usually reflected as a behavior characteristic of the non-player object in all the non-player objects included in the target program. Therefore, it is more appropriate to determine a parameter interval for behavior style division according to all the non-player objects included in the target program. For example, in a program A, an overall average attack distance of non-player objects is 10. In this case, a non-player object whose average attack distance is 9 may be considered as a non-player object in a short-range fighting style in the program A. In a program B, an overall average attack distance of non-player objects is 3. In this case, a non-player object whose average attack distance is 9 may be considered as a non-player object in a distance expansion style in the program B.

Based on this, to accurately and appropriately determine a behavior style corresponding to a non-player object, the computer device may define parameter intervals corresponding to different behavior styles based on the behavior parameters of all the non-player objects corresponding to the target program. In a possible implementation, because a non-player object in the non-player object set is a non-player object that may be configured for running in the target program, the computer device may determine behavior parameter boundaries and interval segment lengths based on the behavior parameters respectively corresponding to the non-player objects included in the non-player object set. The behavior parameter boundary refers to a range boundary of behavior parameters possibly corresponding to all behavior styles, and may include, for example, a maximum value and a minimum value of the behavior parameters. A behavior parameter that falls within a total parameter interval formed by the behavior parameter boundaries has a corresponding behavior style. That is, the corresponding behavior style can be determined provided that the behavior parameter falls within the total parameter interval formed by the behavior parameter boundaries. The total parameter interval includes parameter intervals respectively corresponding to a plurality of behavior styles. The computer device may determine the behavior parameter boundaries and the interval segment lengths by analyzing a distribution status of the behavior parameters respectively corresponding to the non-player objects in the non-player object set. For example, a maximum value and a minimum value of the behavior parameters respectively corresponding to the non-player objects may be used as the behavior parameter boundaries.

The interval segment lengths are interval lengths of the parameter intervals that respectively correspond to the behavior styles and that are obtained through division, and the computer device may divide, according to the behavior parameter boundaries and the interval segment length, the total parameter interval into parameter intervals respectively corresponding to the plurality of behavior styles, the interval segment length being a length between interval starting points of two adjacent parameter intervals. That is, a behavior parameter boundary is used as a starting point, and the total parameter interval may be divided by each interval segment length to obtain a parameter interval corresponding to one behavior style.

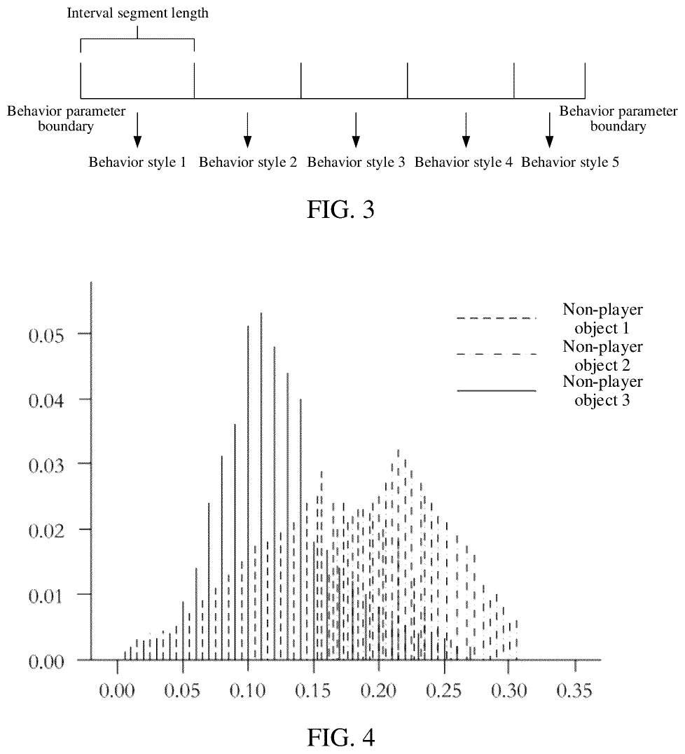

FIG. 3 is a schematic diagram of parameter interval division according to an aspect described herein. An interval length of a parameter interval corresponding to the last behavior style obtained through division in this manner might not satisfy the interval segment length. Therefore, it is defined herein that a length between interval starting points of two adjacent parameter intervals satisfies the interval segment length.

Specifically, division of a parameter interval corresponding to a behavior style is a key factor affecting object construction accuracy, because interval division directly affects judging of the behavior style. If a parameter interval related to a behavior style is excessively large, excessive behavior styles are generated, making it difficult to construct an object in each behavior style during object construction, and may include a behavior style that does not appear in the target program. Therefore, object construction does not fit an actual behavior characteristic of a non-player object in the target program. If a parameter interval is excessively small, some behavior styles may be missed during object construction. Consequently, behavior styles of non-player objects constructed by object construction are non-diversified and not comprehensive enough. Therefore, the computer device needs to accurately determine the behavior parameter boundaries and the interval segment lengths, to determine a relatively appropriate parameter interval corresponding to each behavior style.

In a possible implementation, Usually, a parameter distribution of behavior parameters corresponding to each non-player object fits a distribution characteristic of Gaussian distribution. That is, because a behavior style of a single non-player object is relatively stable, even though the corresponding behavior parameters may fluctuate in the target program, the corresponding behavior parameters are still concentrated in a parameter region. Therefore, the computer device may analyze behavior parameter distribution of each non-player object in the non-player object set based on Gaussian distribution, to determine the behavior parameter boundaries and the interval segment lengths.

In this implementation, behavior parameters corresponding to the target non-player object may include a plurality of behavior parameters. The plurality of behavior parameters may be behavior parameters respectively corresponding to a plurality of behaviors of the target non-player object in the target program. Because scenes faced by the target non-player object when the behaviors are executed and states of the non-player objects may be different, the corresponding behavior parameters may also be different when the behaviors are executed. For example, although attack behaviors are similarly performed, such a parameter as an attack distance corresponding to each attack behavior may be different. The target non-player object may be any non-player object included in the non-player object set, and a difference between the plurality of behavior parameters is configured for representing a behavior parameter fluctuation status of the target non-player object in the target program.

Because the behavior style of the target non-player object is relatively stable, the parameter distributions of the plurality of behavior parameters corresponding to the target non-player object are usually concentrated in a parameter interval range corresponding to the behavior style, that is, fits a parameter distribution characteristic of Gaussian distribution to some extent. Based on this, when determining behavior parameter boundaries and interval segment lengths based on the behavior parameters respectively corresponding to the non-player objects included in the non-player object set, the computer device may use each of the non-player objects in the non-player object set as the target non-player object by using a characteristic of Gaussian distribution, and determine an average value and a variance of the plurality of behavior parameters corresponding to the target non-player object. In Gaussian distribution, parameters are usually concentrated in a parameter interval from a sum of the average value and the variance to a difference between the average value and the variance. Therefore, the computer device may determine an upper parameter boundary corresponding to the target non-player object based on a sum of the average value and the variance, and determine a lower parameter boundary corresponding to the target non-player object based on a difference between the average value and the variance. A parameter interval formed by the upper parameter boundary and the lower parameter boundary is a parameter interval in which the behavior parameters of the target non-player object are concentrated.

The computer device may determine, as an upper parameter boundary of the behavior parameter boundaries, a minimum value in upper parameter boundaries respectively corresponding to the non-player objects included in the non-player object set, and determine, as a lower parameter boundary of the behavior parameter boundaries, a minimum value in lower parameter boundaries respectively corresponding to the non-player objects included in the non-player object set. Therefore, a total parameter interval formed by the behavior parameter boundaries can include behavior parameters of most non-player objects in the non-player object set, so that a corresponding behavior style can be obtained by analyzing each non-player object as much as possible. In addition, in this manner, it can also be ensured that the total parameter interval formed by the behavior parameter boundaries is not excessively large, and fits a distribution situation of the behavior parameters of the non-player objects in the non-player object set, thereby helping analyze a behavior style corresponding to each non-player object more accurately.

Moreover, the computer device may determine, as the interval segment length, a minimum value in variances respectively corresponding to the non-player objects included in the non-player object set. The variance can reflect a distribution difference between behavior parameters of each non-player object. In the Gaussian distribution, non-player objects with different behavior parameter distributions can be effectively put into different parameter intervals by using the variance as the interval segment length, so that the non-player objects with different behavior parameter distributions can correspond to different behavior styles, to accurately represent a behavior style difference between different non-player objects. Fine-grained interval division can be performed on the total parameter interval by using the minimum value in the variances as the interval segment length, so that the obtained parameter interval corresponding to each behavior style is more accurate, facilitating a more detailed analysis of the behavior style. As described herein, the parameter intervals corresponding to the behavior styles may be automatically divided in the foregoing manner. While ensuring accuracy and reasonableness of the parameter intervals, a behavior characteristic of a non-player object in the target program can be better fit without manual participation, thereby reducing dependency on human experience, and further improving object construction efficiency.

For example, in an actual application scenario, the behavior parameter may include a plurality of behavior parameter dimensions. For a j^{th} behavior parameter dimension mⱼ thereof, the computer device needs to determine a behavior parameter boundary [lⱼ, uⱼ] and an interval segment length stepⱼ that correspond to the behavior parameter dimension. Parameter intervals corresponding to behavior styles obtained through division based on the behavior parameter boundary and the interval segment length need to satisfy that behavior parameters of selected N non-player objects having different behavior styles belong to different parameter intervals.

The computer device may perform a running test on the N non-player objects for a plurality of times, to obtain a parameter distribution of a plurality of behavior parameters corresponding to each non-player object. Specifically,

$${m}_{j}^{i}$$

represents a random variable of a behavior parameter of an i^{th} non-player object in the j^{th} behavior parameter dimension, and

$${m}_{j}^{i} \sim {M}_{j}^{i}$$

indicates that the random variable obeys a distribution.

The selected N non-player objects have different styles, and therefore also have different distributions. By calculating an average value

$$μ ( {m}_{j}^{i} )$$

and a variance

$$σ ( {m}_{j}^{i} )$$

of the random variable, the random variable is approximated as a Gaussian distribution.

Therefore, the computer device performs calculation to learn that the lower parameter boundary lⱼ of the behavior parameter boundaries is:

$${l}_{j} = {min}_{i ∈ [ 1 , n ]} \{ μ ( {m}_{j}^{i} ) - 2 σ ( {m}_{j}^{i} ) \}$$

and learn that the upper parameter boundary uⱼ of the behavior parameter boundaries is:

$${u}_{j} = {max}_{i ∈ [ 1 , n ]} \{ μ ( {m}_{j}^{i} ) - 2 σ ( {m}_{j}^{i} ) \}$$

The interval segment length step; may be:

$${step}_{j} = {min}_{i ∈ [ 1 , n ]} σ ( {m}_{j}^{i} )$$

Meanwhile, the computer device may slightly adjust the interval segment length, so that the total parameter interval [lⱼ, uⱼ] can be exactly divided into an integer number of parameter intervals by the interval segment length.

For example, FIG. 4 shows behavior parameter distributions obtained by evaluation of behavior parameters in a behavior parameter dimension among three non-player objects, the horizontal axis represents actual sizes of the behavior parameters, and the vertical axis represents a probability distribution density. Average values of the behavior parameters of the three non-player objects are sequentially [μ(m³), μ(m¹), μ(m²)]=[0.117,0.165,0.210] from left to right. Variances of the three non-player objects are sequentially [σ(m³), σ(m¹), σ(m²)]=[0.053,0.053,0.047] from left to right. After calculation, the behavior parameter dimension corresponds to a behavior parameter boundary of [l, u]=[0.011,0.304] and a segmentation operation of operation=0.049. In this case, average behavior parameters of the three non-player objects in the behavior parameter dimension (considered as behavior parameters in the dimension) may fall within different parameter intervals, so that the behavior styles may be divided.

As described herein, both the behavior parameter boundary and the interval segment length may be updated as the non-player object set is updated, so that the behavior style division can always fit actual object characteristics in the target program.

For ease of understanding the technical solutions provided in the aspects described herein, an object construction method provided herein is described below with reference to an actual application scenario.

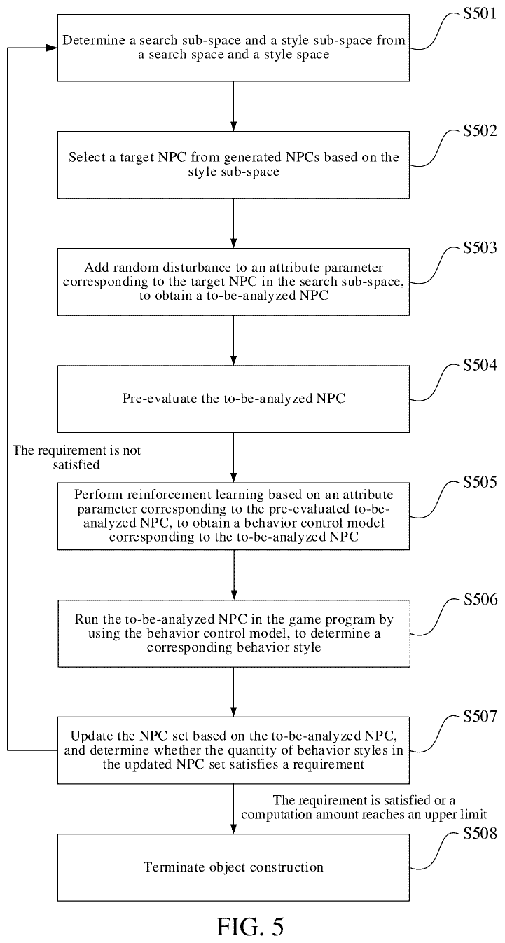

FIG. 5 is a flowchart of an object construction method in an actual application scenario according to an aspect described herein. In the actual application scenario, a target program may be a game program, and a non-player object is an NPC in the game program. An object construction task is configured for constructing non-player objects respectively corresponding to behavior styles in a plurality of behavior style dimensions.

The method includes:

S501: Determine a search sub-space and a style sub-space from a search space and a style space.

In each round of object construction, a computer device may perform sub-task scheduling once, and the sub-task scheduling is configured for determining a search sub-space and a style sub-space. The search space refers to an overall attribute parameter dimension, and the style space refers to an overall behavior parameter dimension. In the actual application scenario, a large number of attribute parameter dimensions and behavior parameter dimensions may be included. Therefore, during each time of object construction, some attribute parameter dimensions may be selected from the attribute parameter dimensions to form a search sub-space, and some behavior parameter dimensions may be selected from the behavior parameter dimensions to form a style sub-space, to perform targeted object construction. The search sub-space and the style sub-space constitute a sub-task in the object construction task, that is, an objective at which the current object construction is targeted.

S502: Select a target NPC from generated NPCs based on the style sub-space.

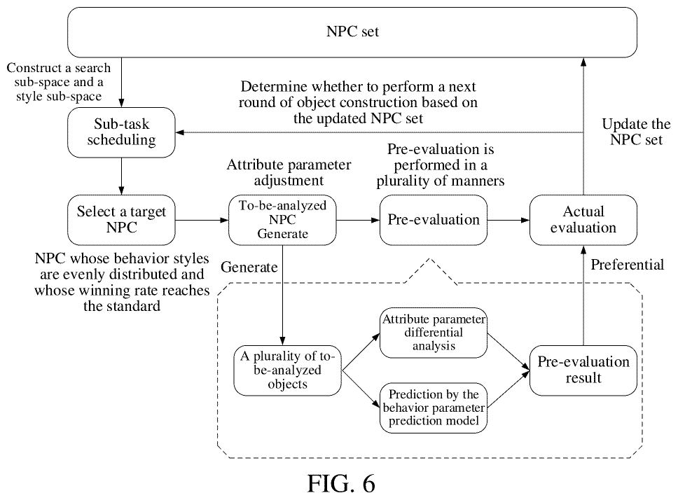

The computer device may select, from the NPCs in the foregoing manners, an NPC that has a new behavior style in a behavior style dimension corresponding to the style sub-space and whose construction is facilitated, as the target NPC. For example, the computer device may evenly select NPCs respectively corresponding to a plurality of behavior styles in the behavior style dimension corresponding to the style sub-space, or may select NPCs based on battle winning rates of the NPCs in a game. This is not limited herein. An overall NPC processing process may be shown in FIG. 6.

S503: Add random disturbance to an attribute parameter corresponding to the target NPC in the search sub-space, to obtain a to-be-analyzed NPC.

As described herein, attribute parameter adjustment during object construction may be implemented based on a Map-Elites (ME) model. The ME model is configured for constructing a plurality of to-be-analyzed objects by means of parameter adjustment, and keeping a most valuable object from the plurality of to-be-analyzed objects. Therefore, a procedure requirement described herein of constructing a plurality of to-be-analyzed NPCs by disturbing an attribute parameter and selecting, from the plurality of to-be-analyzed objects, a to-be-analyzed object needing to be stored into an NPC set can be satisfied. During parameter adjustment, adjustment may be performed on only an attribute parameter in an attribute parameter dimension included in the search sub-space.

S504: Pre-evaluate the to-be-analyzed NPC.

The pre-evaluation is configured for evaluating whether the to-be-analyzed NPC has a relatively large probability of being capable of having a new behavior style. There may be a plurality of pre-evaluation manners. The computer device may perform evaluation based on a difference between attribute parameters of the to-be-analyzed NPC and an existing NPC, or predict a behavior parameter corresponding to the to-be-analyzed NPC by using a behavior parameter prediction model.

S505: Perform reinforcement learning based on an attribute parameter corresponding to the pre-evaluated to-be-analyzed NPC, to obtain a behavior control model corresponding to the to-be-analyzed NPC.

If the pre-evaluation succeeds, it indicates that there is a relatively high probability that the to-be-analyzed NPC has a new behavior style. In this case, the to-be-analyzed NPC may be put into the game program by the computer device, and be tested in a real game environment, to determine an actual behavior parameter corresponding to the to-be-analyzed NPC. First, the computer device may obtain, through training based on the attribute parameter corresponding to the to-be-analyzed NPC, a behavior control model configured for controlling a behavior of the to-be-analyzed NPC in the target program.

S506: Run the to-be-analyzed NPC in the game program by using the behavior control model, to determine a corresponding behavior style.

S507: Update the NPC set based on the to-be-analyzed NPC, and determine whether the quantity of behavior styles in the updated NPC set satisfies a requirement.

There are cases that the to-be-analyzed NPC has a new behavior style, or the to-be-analyzed NPC does not have a new behavior style, but has an attribute parameter greatly different from that of an existing NPC, that is, a different type of attribute parameter in the same behavior style, and has a reference function. Therefore, in all these cases, the to-be-analyzed NPC may be updated to the NPC set. After the update is completed, the computer device may judge whether the quantity of existing behavior styles in the NPC set satisfies a requirement.

S508: Terminate object construction.

If the quantity of behavior styles satisfies the requirement, or a computation amount reaches an upper limit (that is, a quantity of times of running an NPC in the game program reaches an upper limit), object construction may be terminated. If the requirement is not satisfied, and the computation amount does not reach the upper limit, a new round of object construction may be performed.

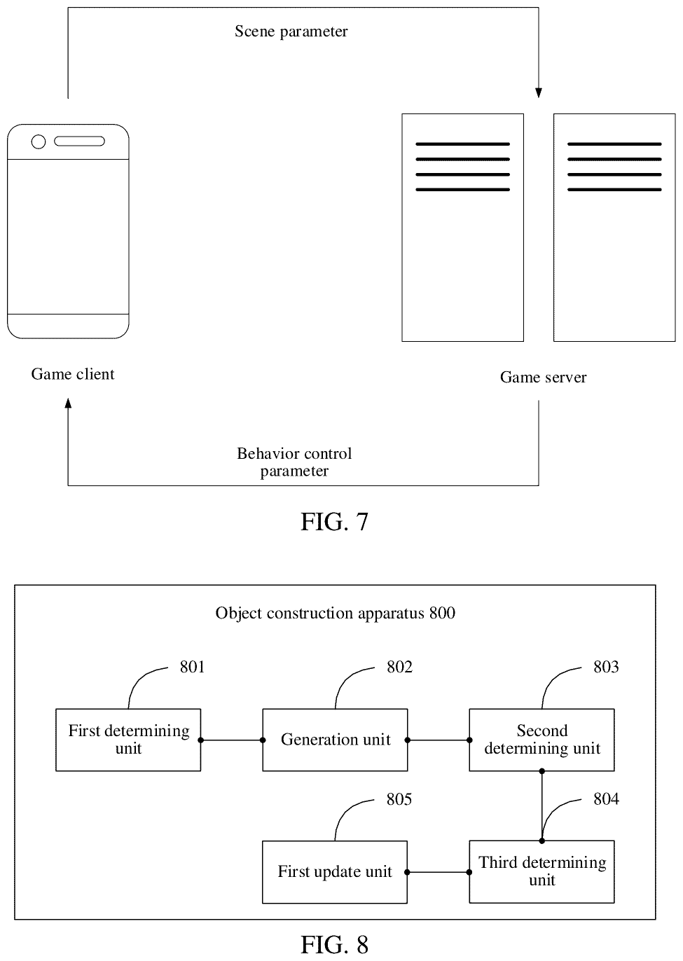

After the NPC set is constructed, NPCs in the NPC set may be put into the game program for running. As shown in FIG. 7, a game client may send scene parameters (such as a scene description parameter and an NPC state parameter) corresponding to a game scene that an NPC faces in the game program to a game server. The game server determines behavior control parameters according to the scene parameters by using an object control model, and sends the behavior control parameters back to the game client, to control a behavior of the NPC in the game program.

Based on the object construction method provided in the foregoing aspects, an aspect described herein further provides an object construction apparatus. FIG. 8 is a structural block diagram of an object construction apparatus 800 according to an aspect described herein, including: a first determining unit 801, a generation unit 802, a second determining unit 803, a third determining unit 804, and a first update unit 805.

The first determining unit 801 is configured to determine a target object in non-player objects included in a non-player object set, the non-player object having an attribute parameter and a behavior parameter, the attribute parameter being configured for controlling a behavior of the non-player object in a target program, the behavior parameter being determined based on the behavior of the non-player object in the target program, and the behavior parameter being configured for representing a behavior style of the non-player object in the target program;
the generation unit 802 is configured to generate an attribute parameter corresponding to a to-be-analyzed object by adding disturbance to the attribute parameter corresponding to the target object;
the second determining unit 803 is configured to run the to-be-analyzed object in the target program according to the attribute parameter corresponding to the to-be-analyzed object, and determine a behavior parameter corresponding to the to-be-analyzed object;
the third determining unit 804 is configured to determine, according to the behavior parameter corresponding to the to-be-analyzed object and behavior parameters respectively corresponding to the non-player objects included in the non-player object set, whether a behavior style corresponding to the to-be-analyzed object is consistent with behavior styles respectively corresponding to the non-player objects included in the non-player object set; and
the first update unit 805 is configured to add, when the behavior style corresponding to the to-be-analyzed object is consistent with none of the behavior styles respectively corresponding to the non-player objects included in the non-player object set, the to-be-analyzed object to the non-player object set.

In a possible implementation, the second determining unit 803 is specifically configured to:
perform reinforcement learning on an initial object control model according to the attribute parameter corresponding to the to-be-analyzed object, to obtain an object control model corresponding to the to-be-analyzed object, the object control model being configured for controlling a behavior of the to-be-analyzed object in the target program; and
run the to-be-analyzed object in the target program by using the object control model, and determine the behavior parameter corresponding to the to-be-analyzed object.

In a possible implementation, the second determining unit 803 is specifically configured to:
obtain a scene parameter corresponding to the to-be-analyzed object in the target program, where the scene parameter is configured for identifying a behavior scene corresponding to the to-be-analyzed object in the target program;
determine a behavior control parameter based on the scene parameter by using the initial object control model, where the behavior control parameter is configured for controlling the to-be-analyzed object to perform a target behavior in the behavior scene;
determine a reward feedback degree for the initial object control model according to a fitting degree between the target behavior and the attribute parameter corresponding to the to-be-analyzed object, where the reward feedback degree is positively correlated to the fitting degree; and
adjust a model parameter corresponding to the initial object control model based on the reward feedback degree, to obtain the object control model, where the object control model is configured for controlling a behavior of the to-be-analyzed object in the target program based on the scene parameter corresponding to the to-be-analyzed object in the target program.

In a possible implementation, the apparatus further includes a fourth determining unit:
the fourth determining unit is configured to determine differences between the attribute parameter corresponding to the to-be-analyzed object and the attribute parameters respectively corresponding to the non-player objects included in the non-player object set; and
the second determining unit 803 is specifically configured to:
run, if the differences between the attribute parameter corresponding to the to-be-analyzed object and the attribute parameters respectively corresponding to the non-player objects included in the non-player object set are all greater than a first preset threshold, the to-be-analyzed object in the target program according to the attribute parameter corresponding to the to-be-analyzed object, and determine the behavior parameter corresponding to the to-be-analyzed object.

In a possible implementation, the apparatus further includes a second update unit:
the second update unit is configured to add, if the differences between the attribute parameter corresponding to the to-be-analyzed object and the attribute parameters respectively corresponding to the non-player objects included in the non-player object set are all greater than the first preset threshold and the non-player object set has a non-player object corresponding to a behavior style consistent with the behavior style corresponding to the to-be-analyzed object, the to-be-analyzed object to the non-player object set.

In a possible implementation, the apparatus further includes a fifth determining unit:
the fifth determining unit is configured to determine a predicted behavior parameter corresponding to the to-be-analyzed object by using a behavior parameter prediction model and according to the attribute parameter corresponding to the to-be-analyzed object, the behavior parameter prediction model being configured for predicting a behavior parameter corresponding to the non-player object in the target program based on the attribute parameter corresponding to the non-player object; and
the fourth determining unit is specifically configured to:
run, if the differences between the predicted behavior parameter and the behavior parameters respectively corresponding to the non-player objects included in the non-player object set are all greater than a second preset threshold, the to-be-analyzed object in the target program according to the attribute parameter corresponding to the to-be-analyzed object, and determine the behavior parameter corresponding to the to-be-analyzed object.

In a possible implementation, the behavior parameter prediction model is obtained through training in the following manner:
obtaining a sample non-player object set, where the sample non-player object set includes a plurality of sample non-player objects, and the plurality of sample non-player objects have corresponding attribute parameters and behavior parameters;
using each of the plurality of sample non-player objects as a target sample object, and determining, by using an initial behavior parameter prediction model, a to-be-determined behavior parameter according to an attribute parameter corresponding to the target sample object; and
adjusting, according to a difference between the to-be-determined behavior parameter and a behavior parameter corresponding to the target sample object, a model parameter corresponding to the initial behavior parameter prediction model, to obtain the behavior parameter prediction model.

In a possible implementation, the behavior parameter includes a behavior parameter in a target behavior parameter dimension, the behavior parameter in the target behavior parameter dimension is configured for representing a behavior style in a target behavior style dimension, and a plurality of behavior styles are included in the target behavior style dimension; and
the first determining unit 801 is specifically configured to:
determine a plurality of to-be-processed objects in the non-player objects included in the non-player object set based on the behavior parameters respectively corresponding to the non-player objects included in the non-player object set, where the plurality of to-be-processed objects includes non-player objects having different corresponding behavior styles in the target behavior style dimension; and
determine each of the plurality of to-be-processed objects as the target object.

In a possible implementation, the first determining unit 801 is specifically configured to:
determine, based on the behavior parameters respectively corresponding to the non-player objects included in the non-player object set, a quantity of non-player objects respectively corresponding to a plurality of behavior styles in the target behavior style dimension in the non-player object set; and
determine a plurality of to-be-processed objects in the non-player objects included in the non-player object set based on the quantity of non-player objects respectively corresponding to a plurality of behavior styles in the target behavior style dimension in the non-player object set, where a quantity of objects corresponding to a target behavior style in the plurality of to-be-processed objects is negatively correlated to a quantity of non-player objects corresponding to the target behavior style in the non-player object set, and the target behavior style is any behavior style under the target behavior style dimension.

In a possible implementation, the apparatus further includes a sixth determining unit:
the sixth determining unit is configured to determine task execution success rates respectively corresponding to the non-player objects included in the non-player object set, the task execution success rate being a success rate of executing a target task by the non-player object in the target program, and the target task being configured for testing an object capability of the non-player object; and
the first determining unit 801 is specifically configured to:
determine the plurality of to-be-processed objects in the non-player objects included in the non-player object set based on the behavior parameters and the task execution success rates respectively corresponding to the non-player objects included in the non-player object set, the task execution success rates respectively corresponding to the plurality of to-be-processed objects being all greater than a third preset threshold.

In a possible implementation, the apparatus further includes an obtaining unit:
the obtaining unit is configured to obtain an object construction request, the object construction request being configured for requesting to construct a non-player object corresponding to a to-be-constructed behavior style dimension; and
the first determining unit 801 is specifically configured to:
determine the to-be-constructed behavior style dimension as the target behavior style dimension, and determine the plurality of to-be-processed objects in the non-player objects included in the non-player object set based on the behavior parameters respectively corresponding to the non-player objects included in the non-player object set.

In a possible implementation, an object construction task includes a plurality of rounds of object construction, the behavior parameter includes a plurality of behavior parameter dimensions, behavior style dimensions represented by behavior parameters in the different behavior parameter dimensions are different, and the first determining unit 801 is specifically configured to:
determine the target behavior parameter dimension in the plurality of behavior parameter dimensions during an i^{th} round of object construction in the plurality of rounds of object construction, where the target behavior parameter dimension is any behavior parameter dimension of the plurality of behavior parameter dimensions, and i is a positive integer; and
determine the plurality of to-be-processed objects in the non-player objects included in the non-player object set based on the behavior parameters respectively corresponding to the non-player objects included in the non-player object set; and
the apparatus further includes a judging unit and an executing unit:
the judging unit is configured to judge, after update of the non-player object set is completed by using a to-be-analyzed object of the i^{th} round of object construction, whether a non-player object included in the non-player object set satisfies a behavior style requirement corresponding to the object construction task; and
the executing unit is configured to perform, if no non-player object included in the non-player object set satisfies the behavior style requirement corresponding to the object construction task, an (i+1)^{th} round of object construction in the plurality of rounds of object construction.

In a possible implementation, the attribute parameter includes a plurality of attribute parameter dimensions, and the apparatus further includes a seventh determining unit:
the seventh determining unit is configured to determine the target attribute parameter dimension in the plurality of attribute parameter dimensions during the i^{th} round of object construction, where the target attribute parameter dimension is any attribute parameter dimension of the plurality of attribute parameter dimensions; and
the generation unit 802 is specifically configured to:
generate the attribute parameter corresponding to the to-be-analyzed object by adding random disturbance to an attribute parameter corresponding to the target object in the target attribute parameter dimension.

In a possible implementation, the third determining unit 804 is specifically configured to:
determine, according to a behavior parameter corresponding to a to-be-determined object and parameter intervals respectively corresponding to a plurality of behavior styles, a target parameter interval to which the behavior parameter corresponding to the to-be-determined object belongs, where the to-be-determined object is any one of the to-be-analyzed object and the non-player objects included in the non-player object set, and parameter intervals corresponding to different behavior styles are different; and
determine a behavior style corresponding to the target parameter interval as a behavior style corresponding to the to-be-determined object.

In a possible implementation, the apparatus further includes an eighth determining unit and a division unit:
the eighth determining unit is configured to determine behavior parameter boundaries and an interval segment length based on the behavior parameters respectively corresponding to the non-player objects included in the non-player object set, behavior parameters falling within a total parameter interval formed by the behavior parameter boundaries having corresponding behavior styles; and
the division unit is configured to divide, according to the behavior parameter boundaries and the interval segment length, the total parameter interval into parameter intervals respectively corresponding to the plurality of behavior styles, the interval segment length being a length between interval starting points of two adjacent parameter intervals.

In a possible implementation, behavior parameters corresponding to a target non-player object include a plurality of behavior parameters, a difference between the plurality of behavior parameters is configured for representing a behavior parameter fluctuation status of the target non-player object in the target program, the target non-player object is any one of the non-player objects included in the non-player object set, and the eighth determining unit is specifically configured to:
use each of the non-player objects in the non-player object set as the target non-player object, and determine an average value and a variance of the plurality of behavior parameters corresponding to the target non-player object;
determine an upper parameter boundary corresponding to the target non-player object based on a sum of the average value and the variance, and determine a lower parameter boundary corresponding to the target non-player object based on a difference between the average value and the variance; and
determine, as an upper parameter boundary of the behavior parameter boundaries, a minimum value in upper parameter boundaries respectively corresponding to the non-player objects included in the non-player object set, determine, as a lower parameter boundary of the behavior parameter boundaries, a minimum value in lower parameter boundaries respectively corresponding to the non-player objects included in the non-player object set, and determine, as the interval segment length, a minimum value in variances respectively corresponding to the non-player objects included in the non-player object set.

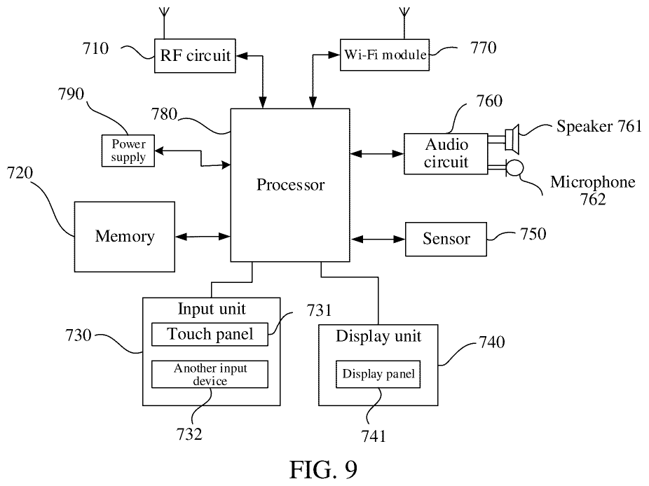

An aspect described herein further provides a computer device. Referring to FIG. 9, the computer device may be a terminal device. The terminal device being a mobile phone is used as an example.

FIG. 9 is a block diagram of a partial structure of a mobile phone related to a terminal device according to an aspect described herein. Referring to FIG. 9, the mobile phone includes: a radio frequency (RF) circuit 710, a memory 720, an input unit 730, a display unit 740, a sensor 750, an audio circuit 760, a wireless fidelity (Wi-Fi) module 770, a processor 780, a power supply 790, and other components. A person skilled in the art may understand that the structure, shown in FIG. 9, of the mobile phone does not constitute a limitation on the mobile phone, and the mobile phone may include more or fewer components than those shown in the figure, or a combination of some components, or a different component deployment may be used.

The following specifically describes the components of the mobile phone with reference to FIG. 9.

The RF circuit 710 may be configured to receive and send signals during receiving and sending information or a call process, particularly, after receiving downlink information from a base station, delivering the downlink information to the processor 780 for processing, and sending the design uplink data to the base station. Generally, the RF circuit 710 includes, but is not limited to, an antenna, at least one amplifier, a transceiver, a coupler, a low noise amplifier (LNA), a duplexer, and the like. In addition, the RF circuit 710 may also communicate with a network and another device by wireless communication. The wireless communication may use any communications standard or protocol, which includes, but is not limited to, a Global System for Mobile communications (GSM), General Packet Radio Service (GPRS), Code Division A plurality of Access (CDMA), Wideband Code Division A plurality of Access (WCDMA), Long Term Evolution (LTE), email, Short Messaging Service (SMS), and the like.

The memory 720 may be configured to store a software program and a module. The processor 780 runs the software program and the module that are stored in the memory 720, to perform various functional applications and data processing of the mobile phone. The memory 720 may mainly include a program storage area and a data storage area. The program storage area may store an operating system, an application required for at least one function (for example, a sound playback function and an image playback function), and the like. The data storage region may store data (for example, audio data and a phone book) created based on use of the mobile phone and the like. In addition, the memory 720 may include a high speed random access memory, and may further include a non-volatile memory, for example, at least one magnetic disk storage device, a flash memory, or another volatile solid-state storage device.

The input unit 730 may be configured to receive input digit or character information, and generate a keyboard signal input related to user settings and function control of the mobile phone. Specifically, the input unit 730 may include a touch panel 731 and another input device 732. The touch panel 731, which may also be referred to as a touchscreen, may collect a touch operation of a user on or near the touch panel 731 (such as an operation of a user on or near the touch panel 731 by using any suitable object or accessory such as a finger or a stylus), and drive a corresponding connection apparatus according to a preset program. In one aspect, the touch panel 731 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, sends the touch point coordinates to the processor 780, moreover, and receives and executes a command sent from the processor 780. In addition, the touch panel 731 may be implemented using various types, such as a resistive type, a capacitance type, an infrared type, and a surface acoustic wave type. In addition to the touch panel 731, the input unit 730 may further include the another input device 732. Specifically, the another input device 732 may include, but is not limited to, one or more of a physical keyboard, a functional key (such as a volume control key or a switch key), a track ball, a mouse, and a joystick.

The display unit 740 may be configured to display information inputted by a user or information provided for the user, and various menus of the mobile phone. The display unit 740 may include a display panel 741. In one aspect, the display panel 741 may be configured using a liquid crystal display (LCD), an organic light-emitting diode (OLED), or the like. Further, the touch panel 731 may cover the display panel 741. After detecting a touch operation on or near the touch panel 731, the touch panel transfers the touch operation to the processor 780, so as to determine a type of a touch event. Then, the processor 780 provides corresponding visual output on the display panel 741 according to the type of the touch event. Although, in FIG. 9, the touch panel 731 and the display panel 741 are used as two separate parts to implement input and output functions of the mobile phone, in some aspects, the touch panel 731 and the display panel 741 may be integrated to implement the input and output functions of the mobile phone.

The mobile phone may further include at least one sensor 750 such as an optical sensor, a motion sensor, and other sensors. Specifically, the optical sensor may include an ambient light sensor and a proximity sensor, where the ambient light sensor may adjust luminance of the display panel 741 according to brightness of the ambient light, and the proximity sensor may switch off the display panel 741 and/or backlight when the mobile phone is moved to the ear. As one type of motion sensor, an acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock). Other sensors which are configured in the mobile phone, such as a gyroscope, a barometer, a hygrometer, a thermometer, and an infrared sensor, are not further described herein.

The audio circuit 760, a speaker 761, and a microphone 762 may provide audio interfaces between the user and the mobile phone. The audio circuit 760 may convert received audio data into an electric signal and transmit the electric signal to the speaker 761. The speaker 761 converts the electric signal into a sound signal and outputs the sound signal. In addition, the microphone 762 converts a collected sound signal into an electrical signal. After receiving the electrical signal, the audio circuit 760 converts the electrical signal into audio data, and then outputs the audio data. After processed by the processor 780, the audio data is transmitted through the RF circuit 710 to, for example, another mobile phone or the audio data is outputted to the memory 720 for further processing.

Wi-Fi is a short-distance wireless transmission technology. The mobile phone may help, by using the Wi-Fi module 770, the user to receive and transmit an email, browse a web page, access stream media, and the like, to allow wireless broadband Internet access of the user. The Wi-Fi module 770 is shown in FIG. 9, but is not a necessary component of the mobile phone, and may be omitted as required provided that the scope of the essence of the present disclosure is not changed.

The processor 780 is the control center of the mobile phone, and is connected to various parts of the mobile phone by using various interfaces and lines. By running or executing the software program and/or module stored in the memory 720, and invoking data stored in the memory 720, the processor performs various functions and data processing of the mobile phone, thereby performing overall detection on the mobile phone. In one aspect, the processor 780 may include one or more processing units. Preferably, an application processor and a modem processor may be integrated into the processor 780. The application processor mainly processes an operating system, a user interface, an application, and the like. The modem processor mainly processes wireless communication. The foregoing modem might not be integrated into the processor 780.

The mobile phone further includes the power supply 790 (such as a battery) for supplying power to the components. Preferably, the power supply may be logically connected to the processor 780 by using a power management system, thereby implementing functions such as charging, discharging, and power consumption management by using the power management system.

Although not shown in the figure, the mobile phone may further include a camera, a Bluetooth module, and the like, which are not further described herein.

In this aspect, the processor 780 included in the terminal device is further configured to perform the object construction method provided in the aspects described herein.

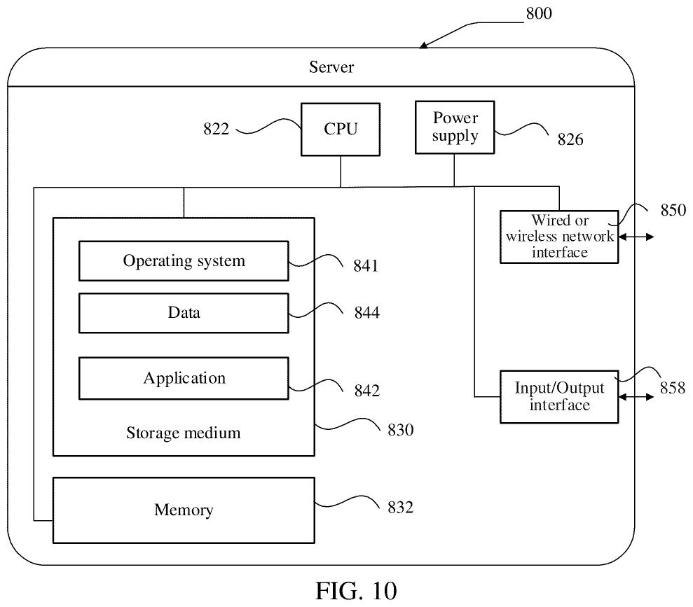

An aspect described herein further provides a server. FIG. 10 is a structural diagram of a server 800 according to an aspect described herein. The server 800 may vary greatly due to different configurations or performance, and may include one or more central processing units (CPUs) 822 (for example, one or more processors), a memory 832, and one or more storage media 830 (for example, one or more mass storage devices) that store applications 842 or data 844. The memory 832 and the storage medium 830 may be transient or persistent storages. The program stored in the storage medium 830 may include one or more modules (not marked in the figure), and each module may include a series of instruction operations to the server. Further, the CPU 822 may be configured to communicate with the storage medium 830, and perform, on the server 800, the series of instruction operations in the storage medium 830.

The server 800 may further include one or more power supplies 826, one or more wired or wireless network interfaces 850, one or more input/output interfaces 858, and/or one or more operating systems 841, for example, Windows Server™, Mac OS X™, Unix™, Linux™, or FreeBSD™

Operations performed by the server in the foregoing aspects may be based on the server structure shown in FIG. 10.

Aspects described herein further provide a computer-readable storage medium, configured to store a computer program. The computer program is configured for performing any one of the implementations of the object construction method according to the foregoing aspects.

Aspects described herein further provide a computer program product including a computer program. The computer program, when run on a computer device, causes the computer device to perform the object construction method in any one of the foregoing aspects.

In the specific implementation described herein, relevant data such as user information (for example, information such as a behavior parameter obtained when a game program tests interaction between an NPC and a user) is involved. When the foregoing aspects described herein are applied to a specific product or technology, a permission or consent of a user is required, and collection, use, and processing of the related data need to comply with relevant laws, regulations, and standards of relevant countries and regions.

A person of ordinary skill in the art may understand that all or some operations for implementing the foregoing method aspects may be completed by a program instructing related hardware, the foregoing program may be stored in a computer-readable storage medium, and the program, when executed, performs operations including the foregoing method aspects. The foregoing storage medium may be at least one of the following media: a read-only memory (ROM), a random access memory (RAM), a magnetic disk, an optical disc, or any medium that can store program code.

The aspects of this specification are all described in a progressive manner. For same or similar parts in the aspects, refer to these aspects. Descriptions of each aspect focus on a difference from other aspects. Especially, device and system aspects are basically similar to the method aspects, and therefore is described briefly. For related parts, refer to partial descriptions in the method aspects. The described device and system aspects are merely exemplary. The units described as separate parts may or might not be physically separated, and parts displayed as units may or might not be physical units, may be located in one position, or may be distributed on a plurality of network units. Some or all of the modules may be selected according to actual needs to achieve the objectives of the solutions of this aspect. A person of ordinary skill in the art may understand and implement the aspects without creative efforts.

The foregoing descriptions are merely a specific implementation described herein, but are not intended to limit the protection scope described herein. Any variation or replacement readily figured out by a person skilled in the art within the technical scope disclosed described herein shall fall within the protection scope described herein. Therefore, the protection scope described herein shall be subject to the protection scope of the claims.

What is claimed is:

1. A computer-implemented method, comprising:
determining a target non-player character (NPC) from a plurality of non-player characters, the non-player character having an attribute parameter and a behavior parameter, wherein the attribute parameter is configured for controlling a behavior of the non-player character in a target program, the behavior parameter being determined based on the behavior of the non-player character in the target program, and the behavior parameter being configured for representing a behavior style of the non-player character in the target program;
generating an attribute parameter corresponding to a to-be-analyzed NPC by adding disturbance to the attribute parameter corresponding to the target NPC;
running the to-be-analyzed NPC in the target program according to the attribute parameter corresponding to the to-be-analyzed NPC, and determining a behavior parameter corresponding to the to-be-analyzed NPC;
determining, according to the behavior parameter corresponding to the to-be-analyzed NPC and behavior parameters respectively corresponding to each of the plurality of non-player characters, whether a behavior style corresponding to the to-be-analyzed NPC matches any of the behavior styles respectively corresponding to the plurality of NPCs, within a predefine match threshold; and
adding, when the behavior style corresponding to the to-be-analyzed NPC does not match any of the behavior styles respectively corresponding to the plurality of NPC, the to-be-analyzed NPC to the non-player object set.

2. The method according to claim 1, wherein the running the to-be-analyzed NPC in the target program and determining a behavior parameter comprises:
performing reinforcement learning on an initial object control model according to the attribute parameter corresponding to the to-be-analyzed NPC, to obtain an object control model corresponding to the to-be-analyzed NPC, the object control model being configured for controlling a behavior of the to-be-analyzed NPC in the target program; and
running the to-be-analyzed NPC in the target program by using the object control model, and determining the behavior parameter corresponding to the to-be-analyzed NPC.

3. The method of claim 2, wherein the performing reinforcement learning comprises:
obtaining a scene parameter corresponding to the to-be-analyzed NPC in the target program, wherein the scene parameter is configured for identifying a behavior scene corresponding to the to-be-analyzed NPC in the target program;
determining a behavior control parameter based on the scene parameter by using the initial object control model, wherein the behavior control parameter is configured for controlling the to-be-analyzed NPC to perform a target behavior in the behavior scene;
determining a reward feedback degree for the initial object control model according to a fitting degree between the target behavior and the attribute parameter corresponding to the to-be-analyzed NPC, wherein the reward feedback degree is positively correlated to the fitting degree; and
adjusting a model parameter corresponding to the initial object control model based on the reward feedback degree, to obtain the object control model, wherein the object control model is configured for controlling a behavior of the to-be-analyzed NPC in the target program based on the scene parameter corresponding to the to-be-analyzed object in the target program.

4. The method of claim 1, further comprising:
determining differences between the attribute parameter corresponding to the to-be-analyzed NPC and the attribute parameters respectively corresponding to each of the plurality of NPCs; and
the running the to-be-analyzed object in the target program and determining a behavior parameter comprises:
running, when the differences between the attribute parameter corresponding to the to-be-analyzed NPC and the attribute parameters respectively corresponding to each of the plurality of NPCs are all greater than a first preset threshold, the to-be-analyzed NPC in the target program according to the attribute parameter corresponding to the to-be-analyzed NPC, and determining the behavior parameter corresponding to the to-be-analyzed NPC.

5. The method of claim 1, further comprising:
adding, when the differences between the attribute parameter corresponding to the to-be-analyzed NPC and the attribute parameters respectively corresponding to each of the plurality of NPCs are all greater than the first preset threshold and the plurality of NPCs has a NPC corresponding to a behavior style consistent with the behavior style corresponding to the to-be-analyzed NPC, the to-be-analyzed NPC to the non-player object set.

6. The method of claim 1, further comprising:
determining a predicted behavior parameter corresponding to the to-be-analyzed NPC by using a behavior parameter prediction model and according to the attribute parameter corresponding to the to-be-analyzed NPC, the behavior parameter prediction model being configured for predicting a behavior parameter corresponding to the non-player character in the target program based on the attribute parameter corresponding to the non-player character; and
the running the to-be-analyzed NPC in the target program according to the attribute parameter corresponding to the to-be-analyzed NPC, and determining a behavior parameter corresponding to the to-be-analyzed NPC comprising:
running, when the differences between the predicted behavior parameter and the behavior parameters respectively corresponding to each of the plurality of NPCs are all greater than a second preset threshold, the to-be-analyzed NPC in the target program according to the attribute parameter corresponding to the to-be-analyzed NPC, and determining the behavior parameter corresponding to the to-be-analyzed NPC.

7. The method of claim 1, wherein the behavior parameter prediction model is obtained through training by:
obtaining a sample non-player character set, wherein the sample non-player character set comprises a plurality of sample non-player characters, and the plurality of sample non-player characters have corresponding attribute parameters and behavior parameters;
using each of the plurality of sample non-player characters as a target sample NPC, and determining, by using an initial behavior parameter prediction model, a to-be-determined behavior parameter according to an attribute parameter corresponding to the target sample NPC; and
adjusting, according to a difference between the to-be-determined behavior parameter and a behavior parameter corresponding to the target sample NPC, a model parameter corresponding to the initial behavior parameter prediction model, to obtain the behavior parameter prediction model.

8. The method of claim 1, wherein the behavior parameter comprises a behavior parameter in a target behavior parameter dimension, the behavior parameter in the target behavior parameter dimension being configured for representing a behavior style in a target behavior style dimension, wherein the behavior style is one of a plurality of behavior styles in the target behavior style dimension; and
The determining the target non-player character (NPC) from a plurality of non-player characters comprises:
determining a plurality of to-be-processed NPCs in the plurality of NPCs based on the behavior parameters respectively corresponding to each of the non-player characters in the plurality of NPCs, wherein the plurality of to-be-processed NPC comprises non-player characters having different corresponding behavior styles in the target behavior style dimension; and
determining each of the plurality of to-be-processed NPCs as the target object.

9. The method of claim 8, wherein the determining the plurality of to-be-processed NPCs comprises:
determining, based on the behavior parameters respectively corresponding to each of the non-player characters in the plurality of NPCs, a quantity of non-player characters respectively corresponding to a plurality of behavior styles in the target behavior style dimension in the non-player object set; and
determining a plurality of to-be-processed NPCs in the plurality of NPCs based on the quantity of non-player characters respectively corresponding to a plurality of behavior styles in the target behavior style dimension in the non-player character set, wherein a quantity of NPCs corresponding to a target behavior style in the plurality of to-be-processed NPCs is negatively correlated to a quantity of non-player characters corresponding to the target behavior style in the non-player character set, and the target behavior style is any behavior style in the target behavior style dimension.

10. The method of claim 9, further comprising:
determining task execution success rates respectively corresponding to the non-player characters comprised in the non-player character set, the task execution success rate being a success rate of executing a target task by the non-player character in the target program, and the target task being configured for testing an object capability of the non-player character; and
the determining a plurality of to-be-processed NPCs in the plurality of NPCs comprises:
determining the plurality of to-be-processed NPCs in the non-player characters comprised in the non-player character set based on the behavior parameters and the task execution success rates respectively corresponding to the non-player characters comprised in the non-player character set, the task execution success rates respectively corresponding to the plurality of to-be-processed NPCs being all greater than a third preset threshold.

11. The method of claim 10, further comprising:
obtaining a character construction request, the character construction request being configured for requesting to construct a non-player character corresponding to a to-be-constructed behavior style dimension; and
the determining the plurality of to-be-processed objects comprises:
determining the to-be-constructed behavior style dimension as the target behavior style dimension, and determining the plurality of to-be-processed objects in the non-player objects comprised in the non-player object set based on the behavior parameters respectively corresponding to the non-player characters comprised in the non-player object set.

12. The method of claim 1, wherein a character construction task comprises a plurality of rounds of character construction, the behavior parameter comprises a plurality of behavior parameter dimensions, behavior style dimensions represented by behavior parameters in the different behavior parameter dimensions are different, and the determining a plurality of to-be-processed characters in the plurality of NPCs comprises:
determining the target behavior parameter dimension in the plurality of behavior parameter dimensions during an i^{th} round of character construction in the plurality of rounds of character construction, wherein the target behavior parameter dimension is any behavior parameter dimension of the plurality of behavior parameter dimensions, and i is a positive integer; and
determining the plurality of to-be-processed characters in the plurality of NPCs based on the behavior parameters respectively corresponding to the non-player objects comprised in the non-player object set; and
the method further comprises:
judging, after update of the non-player character set is completed by using a to-be-analyzed character of the i^{th} round of object construction, whether a non-player character comprised in the non-player object set satisfies a behavior style requirement corresponding to the object construction task; and
performing, if no non-player character comprised in the non-player character set satisfies the behavior style requirement corresponding to the character construction task, an (i+1)^{th} round of character construction in the plurality of rounds of character construction.

13. The method of claim 1, wherein the attribute parameter comprises a plurality of attribute parameter dimensions, and the method further comprises:
determining the target attribute parameter dimension in the plurality of attribute parameter dimensions during the i^{th} round of character construction, wherein the target attribute parameter dimension is any attribute parameter dimension of the plurality of attribute parameter dimensions; and
the generating an attribute parameter corresponding to a to-be-analyzed character by adding disturbance to the attribute parameter corresponding to the target object comprises:
generating the attribute parameter corresponding to the to-be-analyzed character by adding random disturbance to an attribute parameter corresponding to the target character in the target attribute parameter dimension.

14. The method of claim 1, wherein the determining, according to the behavior parameter corresponding to the to-be-analyzed character and behavior parameters respectively corresponding to the plurality of NPCs, whether a behavior style corresponding to the to-be-analyzed character is consistent with behavior styles respectively corresponding to the plurality of NPCs:
determining, according to a behavior parameter corresponding to a to-be-determined character and parameter intervals respectively corresponding to a plurality of behavior styles, a target parameter interval to which the behavior parameter corresponding to the to-be-determined character belongs, wherein the to-be-determined character is any one of the to-be-analyzed characters and the plurality of NPCs, and parameter intervals corresponding to different behavior styles are different; and
determining a behavior style corresponding to the target parameter interval as a behavior style corresponding to the to-be-determined character.

15. The method of claim 1, further comprising:
determining behavior parameter boundaries and an interval segment length based on the behavior parameters respectively corresponding to the plurality of NPCs, behavior parameters falling within a total parameter interval formed by the behavior parameter boundaries having corresponding behavior styles; and
dividing, according to the behavior parameter boundaries and the interval segment length, the total parameter interval into parameter intervals respectively corresponding to the plurality of behavior styles, the interval segment length being a length between interval starting points of two adjacent parameter intervals.

16. The method of claim 1, wherein behavior parameters corresponding to a target non-player character comprise a plurality of behavior parameters, wherein a difference between the plurality of behavior parameters is configured for representing a behavior parameter fluctuation status of the target non-player character in the target program, the target non-player character is any one of the non-player characters of the plurality of NPCs, and the determining behavior parameter boundaries and an interval segment length based on the behavior parameters respectively corresponding to the non-player character of the plurality of NPCs comprises:
using each of the non-player characters in the non-player character set as the target non-player character, and determining an average value and a variance of the plurality of behavior parameters corresponding to the target non-player character;
determining an upper parameter boundary corresponding to the target non-player character based on a sum of the average value and the variance, and determining a lower parameter boundary corresponding to the target non-player character based on a difference between the average value and the variance; and
determining, as an upper parameter boundary of the behavior parameter boundaries, a minimum value in upper parameter boundaries respectively corresponding to the plurality of NPCs, determining, as a lower parameter boundary of the behavior parameter boundaries, a minimum value in lower parameter boundaries respectively corresponding to the non-player characters comprised in the non-player character set, and determining, as the interval segment length, a minimum value in variances respectively corresponding to the plurality of NPCs.

17. One or more non-transitory computer readable media comprising computer readable instructions which, when executed by a processor, configure a data processing system to perform:
determining a target non-player character (NPC) from a plurality of non-player characters, the non-player character having an attribute parameter and a behavior parameter, wherein the attribute parameter is configured for controlling a behavior of the non-player character in a target program, the behavior parameter being determined based on the behavior of the non-player character in the target program, and the behavior parameter being configured for representing a behavior style of the non-player character in the target program;
generating an attribute parameter corresponding to a to-be-analyzed NPC by adding disturbance to the attribute parameter corresponding to the target NPC;
running the to-be-analyzed NPC in the target program according to the attribute parameter corresponding to the to-be-analyzed NPC, and determining a behavior parameter corresponding to the to-be-analyzed NPC;
determining, according to the behavior parameter corresponding to the to-be-analyzed NPC and behavior parameters respectively corresponding to each of the plurality of non-player characters, whether a behavior style corresponding to the to-be-analyzed NPC matches any of the behavior styles respectively corresponding to the plurality of NPCs, within a predefine match threshold; and
adding, when the behavior style corresponding to the to-be-analyzed NPC does not match any of the behavior styles respectively corresponding to the plurality of NPC, the to-be-analyzed NPC to the non-player object set.

18. The computer readable media of claim 17, wherein the running the to-be-analyzed NPC in the target program and determining a behavior parameter comprises:
performing reinforcement learning on an initial object control model according to the attribute parameter corresponding to the to-be-analyzed NPC, to obtain an object control model corresponding to the to-be-analyzed NPC, the object control model being configured for controlling a behavior of the to-be-analyzed NPC in the target program; and
running the to-be-analyzed NPC in the target program by using the object control model, and determining the behavior parameter corresponding to the to-be-analyzed NPC.

19. A system comprising a processor, and memory storing computer readable instructions which, when executed by the processor, configure the system to perform:
determining a target non-player character (NPC) from a plurality of non-player characters, the non-player character having an attribute parameter and a behavior parameter, wherein the attribute parameter is configured for controlling a behavior of the non-player character in a target program, the behavior parameter being determined based on the behavior of the non-player character in the target program, and the behavior parameter being configured for representing a behavior style of the non-player character in the target program;
generating an attribute parameter corresponding to a to-be-analyzed NPC by adding disturbance to the attribute parameter corresponding to the target NPC;
running the to-be-analyzed NPC in the target program according to the attribute parameter corresponding to the to-be-analyzed NPC, and determining a behavior parameter corresponding to the to-be-analyzed NPC;
determining, according to the behavior parameter corresponding to the to-be-analyzed NPC and behavior parameters respectively corresponding to each of the plurality of non-player characters, whether a behavior style corresponding to the to-be-analyzed NPC matches any of the behavior styles respectively corresponding to the plurality of NPCs, within a predefine match threshold; and
adding, when the behavior style corresponding to the to-be-analyzed NPC does not match any of the behavior styles respectively corresponding to the plurality of NPC, the to-be-analyzed NPC to the non-player object set.

20. The system of claim 19, wherein the running the to-be-analyzed NPC in the target program and determining a behavior parameter comprises:
performing reinforcement learning on an initial object control model according to the attribute parameter corresponding to the to-be-analyzed NPC, to obtain an object control model corresponding to the to-be-analyzed NPC, the object control model being configured for controlling a behavior of the to-be-analyzed NPC in the target program; and
running the to-be-analyzed NPC in the target program by using the object control model, and determining the behavior parameter corresponding to the to-be-analyzed NPC.
